(19) United States
(12) Patent Application Publication
(10) Pub. No.: US 2009/0195813 A1
(43) Pub. Date: Aug. 6, 2009

(54) Image forming apparatus management system and image forming apparatus management method

(75) Inventor: Hiroyuki Shibaki, Tokyo (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/320,448

(22) Filed: Jan. 27, 2009

(30) Foreign Application Priority Data
Feb. 1, 2008 (JP) NO. 2008-023219
Dec. 12, 2008 (JP) NO. 2008-317331

(51) Int. Cl. G06F 3/12

(52) U.S. Cl. 358/1.15

(57) ABSTRACT

An image forming apparatus carries, an image apparatus management apparatus or a client apparatus carries out authentication of a user based on user information input by an operator, the user information is then used by the image apparatus management apparatus to obtain a toner save rate of the user, which is then transmitted to the image forming apparatus or another image forming apparatus which then carries out an image forming process based on the toner save rate.

### BACKGROUND OF THE INVENTION

1. Field of the Invention

The present invention relates to an image forming apparatus management system and an image forming apparatus management method, and in particular, to an image forming apparatus management system and an image forming apparatus management method for managing toner save rates collectively. It is noted that the toner save rate means a factor used to obtain a new pixel value after carrying out toner save processing on an original pixel value according to the following formula (1):

(pixel value after toner save processing)=(pixel value before toner save processing)×(100−“toner save rate [%]”)/100 (1)

2. Description of the Related Art

There is an apparatus which is provided with a toner save mode in which an image is output with a toner amount saved with respect to a normal mode in which a high quality image is generated and output. A case where the toner save mode is used is, for example, a case where a high image quality is not basically required, such as a case for merely checking a layout of an output image. It is possible to save toner consumption by using the toner save mode. As a result, it is possible to reduce the cost per output image, and also, it is possible to save energy consumption required in a fixing process to fix toner to paper. Therefore, it is possible to reduce energy costs, and to reduce environmental load. Thus, an advantage of the toner save mode is increasing.

When toner save rates in an office are managed, not only management of merely printers or management of merely copying machines or image copying apparatuses, but also management of all the machines and apparatuses is required.

In the related art, when a printer is used to output an image, a user himself or herself selects a toner save mode by setting from a user interface of a printer driver. Japanese Laid-Open Patent Application No. 2005-004477 discloses that a server is provided for collectively managing printers' consumables, and, therewith, a management person can control actual amounts of consumables.

Besides a case of printing out mentioned above, for a case of copying, Japanese Laid-Open Patent Application No. 2006-056248 discloses that, use setting information corresponding to each user is held by a copy machine, and use amount control is carried out based on the use setting information based on user authentication. However, a case where a server is provided separately from a copy machine, and the serer is used for use amount control for a case of copying, is not disclosed. Further, a system which manages use amounts in a plurality of copy machines provided in an office is not disclosed. Further, a system which collectively manages two types of image forming apparatuses, i.e., copy machines and printers is not disclosed.

In the related arts described above, it may not be possible to completely solve a problem to collectively manage toner save rates in all machines and apparatuses in an office. This may be because a management person may not be able to collectively manage toner save rates concerning paper output occurring in the office.

### SUMMARY OF THE INVENTION

In consideration of the above-mentioned circumstances, an object of the present invention is to provide a system in which toner save rates can be collectively managed by a management person for users who use image forming apparatuses.

In order to solve the problem, according to the present invention, an image forming apparatus management system has at least one of a first and second image forming apparatuses having a copying function, a third image forming apparatus having a printing out function, a client apparatus, an image apparatus management apparatus and a communication network. The at least one of the first and second image forming apparatuses, the third image forming apparatus, the client apparatus and the image apparatus management apparatus are connected in such a manner that they can communicate with each other through the communication network.

The first image forming apparatus has a first user authentication part configured to carry out authentication of a user based on user information. The first user authentication part carries out authentication of a user based on user information input by an operator, and the first image forming apparatus transmits the user information of the user authenticated by the first user authentication part, to the image apparatus management apparatus. The image apparatus management apparatus has a part configured to hold toner save setting information which sets a toner save rate for each user. When receiving the user information of the user authenticated by the first user authentication part and transmitted by the first image forming apparatus, the image apparatus management apparatus obtains a toner save rate of the user authenticated by the first user authentication part based on the user information of the user, and the toner save setting information held by the part configured to hold the toner save setting information, and transmits information indicating the toner save rate to the first image forming apparatus. The first image forming apparatus then receives the information indicating the toner save rate of the user authenticated by the first user authentication part as mentioned above, transmitted from the image apparatus management apparatus, and carries out an image forming process based on the received toner save rate.

The second image forming apparatus transmits user information input by an operator. The image apparatus management apparatus has a second user authentication part configured to carry out authentication of a user based on user information. When receiving the user information thus transmitted by the second image forming apparatus, the second user authentication part carries out authentication of the user based on the user information. The image apparatus management apparatus then obtains a toner save rate of the user authenticated by the second user authentication part mentioned above, based on the user information of the user and the toner save setting information held by the part configured to hold the toner save setting information, and transmits information indicating the toner save rate to the second image forming apparatus. The second image forming apparatus then receives the information indicating the toner save rate of the user authenticated by the second user authentications part as mentioned above, transmitted from the image apparatus management apparatus, and carries out an image forming process based on the received toner save rate.

The client apparatus has a third user authentication part configured to carry out authentication of a user based on user information. The third user authentication part carries out authentication of a user based on user information input by an operator. The client apparatus then transmits the user information of the user thus authenticated by the third user authentication part, to the third image forming apparatus. The third image forming apparatus then receives the user information of the user authenticated by the third user authentication part as mentioned above, and transmits the user information to the image apparatus management apparatus. The image apparatus management apparatus then receives the user information of the user authenticated by the third user authentication part as mentioned above, transmitted from the third image forming apparatus, and obtains a toner save rate of the user authenticated by the third user authentication part as mentioned above, based on the user information of the user and the toner save setting information held by the part configured to hold the toner save setting information, and transmits information indicating the toner save rate to the third image forming apparatus. Then, the third image forming apparatus receives the information indicating the toner save rate of the user authenticated by the third user authentication part, transmitted from the image apparatus management apparatus, and carries out an image forming process based on the received toner save rate.

According to another aspect, an image forming apparatus management method is for an image forming apparatus management system in which at least one of a first and second image forming apparatuses having a copying function, a third image forming apparatus having a printing out function, a client apparatus and an image apparatus management apparatus are connected in such a manner that they can communicate with each other through a communication network.

In the method, the first image forming apparatus carries out authentication of a user based on user information input by an operator, and transmits the user information of the authenticated user to the image apparatus management apparatus. The image apparatus management apparatus receives the user information of the user transmitted from the first image forming apparatus, and obtains a toner save rate of the user based on the user information thus transmitted from the first image forming apparatus and toner save setting information held by a part configured to hold the toner save setting information, and transmits information indicating the toner save rate to the first image forming apparatus. The first image forming apparatus then receives the information indicating the toner save rate of the user which has been obtained by the image apparatus management apparatus based on the user information which has been transmitted from the first image forming apparatus to the image apparatus management apparatus as mentioned above, and carries out an image forming process based on the received toner save rate.

The second image forming apparatus transmits user information which has been input by an operator, to the image apparatus management apparatus. The image apparatus management apparatus then receives the user information thus transmitted by the second image forming apparatus, carries out authentication of a user based on the user information thus transmitted from the second image forming apparatus, obtains a toner save rate of the user based on the user information thus transmitted from the second image forming apparatus, and the toner save setting information held by the part configured to hold the toner save setting information, and transmits information indicating the toner save rate to the second image forming apparatus. The second image forming apparatus then receives the information indicating the toner save rate of the user, which has been obtained by the image apparatus management apparatus based on the user information which has been transmitted from the second image forming apparatus to the image apparatus management apparatus, and carries out an image forming process based on the received toner save rate.

The client apparatus carries out authentication of a user based on user information which has been input by an operator, and transmits the user information of the thus-authenticated user to the third image forming apparatus. The third image forming apparatus receives the user information thus transmitted from the client apparatus, and transmits the user information to the image apparatus management apparatus. The image apparatus management apparatus then receives the user information from the third image forming apparatus which has been transmitted from the client apparatus to the third image forming apparatus as mentioned above, obtains a toner save rate based on the user information, and the toner save setting information held by the part configured to hold the toner save setting information, and transmits information indicating the toner save rate to the third image forming apparatus. The third image forming apparatus then receives the information indicating the toner save rate which has been obtained by the image apparatus management apparatus based on the user information transmitted from the client apparatus to the image apparatus management apparatus as mentioned above, and carries out an image forming process based on the received toner save rate.

According to the present invention, it is possible that a management person can collectively manages toner save rates of users who use image forming apparatuses.

Other objects, features and advantages of the present invention will become more apparent from the following detailed description when read in conjunction with the accompanying drawings.

### BRIEF DESCRIPTION OF THE DRAWINGS

FIG. 1 depicts an image forming apparatus management system in reference examples and embodiments;

FIG. 2 depicts an image apparatus management apparatus in the reference examples and embodiments;

FIG. 3 depicts a bock diagram of a general configuration of an image copying apparatus in the reference examples and embodiments;

FIG. 4 depicts a configuration of an edge amount calculating part depicted in FIG. 3;

FIG. 5 illustrates an edge amount detecting filter in the reference examples and embodiments;

FIG. 6 depicts a configuration of a filtering part depicted in FIG. 3;

FIG. 7 illustrates a filter used for adaptive edge enhancing processing in the reference examples and embodiments;

FIG. 8 illustrates a filter used for smoothing in the reference examples and embodiments;

FIG. 9 illustrates adaptive edge enhancing processing in the reference examples and embodiments;

FIG. 10 illustrates a filter used for adaptive edge enchainment processing in the reference examples and embodiments;

FIG. 11 illustrates characteristics of an edge amount converting table in the reference examples and embodiments;

FIG. 12 depicts a configuration of a toner save processing part in the reference examples and embodiments;

FIG. 13 illustrates characteristics of a save table depicted in FIG. 12;

FIG. 14 illustrates a toner save rate for each user which is transmitted by the image apparatus management apparatus depicted in FIG. 3;

FIG. 15 depicts a block diagram of another general configuration of an image copying apparatus in the reference examples and embodiments;

FIG. 16 depicts another configuration of the toner save processing part depicted in FIG. 3;

FIG. 17 illustrates settings of toner save rates held by the images apparatus management apparatus depicted in FIG. 3;

FIG. 18 depicts another configuration of the image apparatus management apparatus depicted in FIG. 1;

FIG. 19 depicts a configuration of an image forming apparatus management system in a first embodiment;

FIG. 20 depicts toner save rates held by an image apparatus management apparatus depicted in FIG. 19;

FIG. 21 depicts other setting examples of toner save rates in the image forming apparatus management system in the first embodiment;

FIG. 22 depicts setting examples of toner save rates in an image forming apparatus management system in a second embodiment;

FIG. 23 depicts other setting examples of toner save rates in the image forming apparatus management system in the second embodiment;

FIG. 24 depicts setting examples of toner save rates in an image forming apparatus management system in a third embodiment;

FIG. 25 depicts a processing flow in a first reference example and the first embodiment;

FIG. 26 depicts a processing flow in a second reference example and the first embodiment;

FIG. 27 depicts a processing flow in the first embodiment;

FIG. 28 depicts a processing flow in further another embodiment;

FIG. 29 illustrates a configuration of a table converting part depicted in FIG. 16;

FIG. 30 depicts a block diagram of a hardware configuration example of each of the image apparatus management apparatus and a first client apparatus; and

FIG. 31 depicts a block diagram of a hardware configuration example of each of a first image copying apparatus, a second image copying apparatus, a first print output apparatus and a second print output apparatus.

### DESCRIPTION OF THE REFERENCE NUMERALS

1 NETWORK
2 IMAGE APPARATUS MANAGEMENT APPARATUS
3 FIRST IMAGE COPYING APPARATUS
4 FIRST USER AUTHENTICATION PART
5 SECOND IMAGE COPYING APPARATUS
6 SECOND USER READING PART
7 FIRST CLIENT APPARATUS
8 FIRST PRINT OUTPUT APPARATUS
9 SECOND PRINT OUTPUT APPARATUS
21 PERSONAL SETTING INFORMATION INQUIRING PART
22 USER SETTING INFORMATION
23 AUTHENTICATION PART
24 PERSONAL AUTHENTICATION DATA

### DETAILED DESCRIPTION OF THE PREFERRED EMBODIMENTS

First, reference examples will be described before preferred embodiments will be described.

### First Reference Example

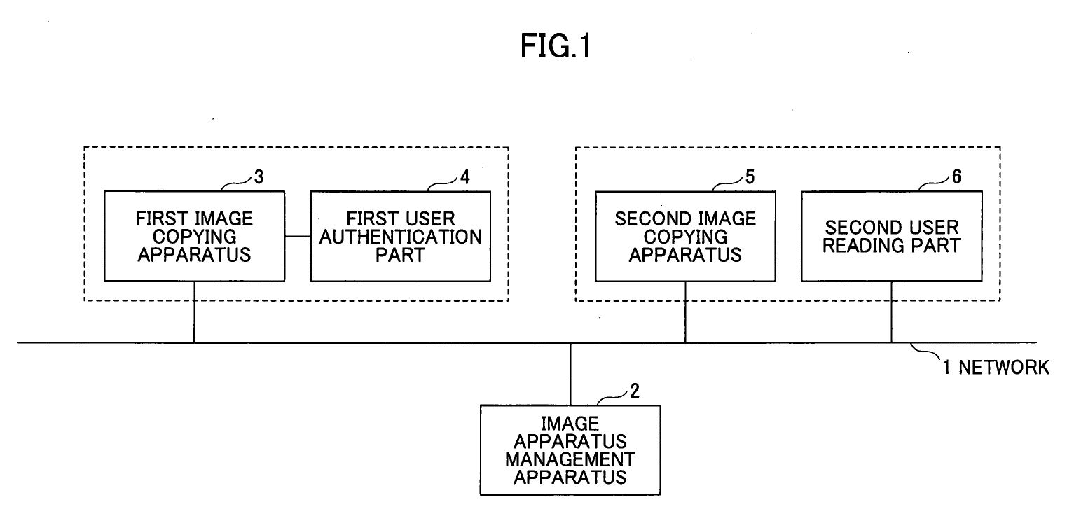

With reference to FIG. 1, an image forming apparatus management system in a first reference example will be described.

As depicted in FIG. 1, the image forming apparatus management system in the first reference example includes a first image copying apparatus 3 (for example, a copier), a second image copying apparatus 5 (for example, another copier), an image apparatus management apparatus 2 and a communication network 1 which connects the first image copying apparatus 3, second image copying apparatus 5, and image apparatus management apparatus 2 in such a manner that they can communication with each other. The first image copying apparatus 3 has a first user authentication part 5 and the second image copying apparatus 5 has a second user reading part 6.

In the first reference example, when a user uses the first image copying apparatus 3 to carry out copying, the first user authentication part 4 carries out user authentication. User authentication may be carried out, for example, by such a method that a user name and a password are used, such a method that an ID card such as a magnetic card is used, or such a method that a non-contact device such as an RF-ID (Radio Frequency IDentification) is used. With the use of any one of these methods or such, the user causes the first authentication part 4 to read user information of the user, or the user inputs the user information to the first authentication part 4. The first authentication part 4 then determines, based on the user information, whether the user is a person who is allowed to use the first image copying apparatus 3. When it is determined that the user is allowed to use the first image copying apparatus 3, the first authentication part 4 transmits the user information of the user to the image apparatus management apparatus 2 from the first image copying apparatus 3. In this case, the first image copying apparatus 3 transmits to the image apparatus management part 2 a user ID (uid) of the user and a machine ID (mid) of the first image copying apparatus 3.

The image apparatus management apparatus 2 then transmits the user ID and a signal indicating that copying operation is allowed, to the first copying apparatus 3, when the result of the determination in the first image authentication part 4 is that the user is allowed to use the first image copying apparatus 3.

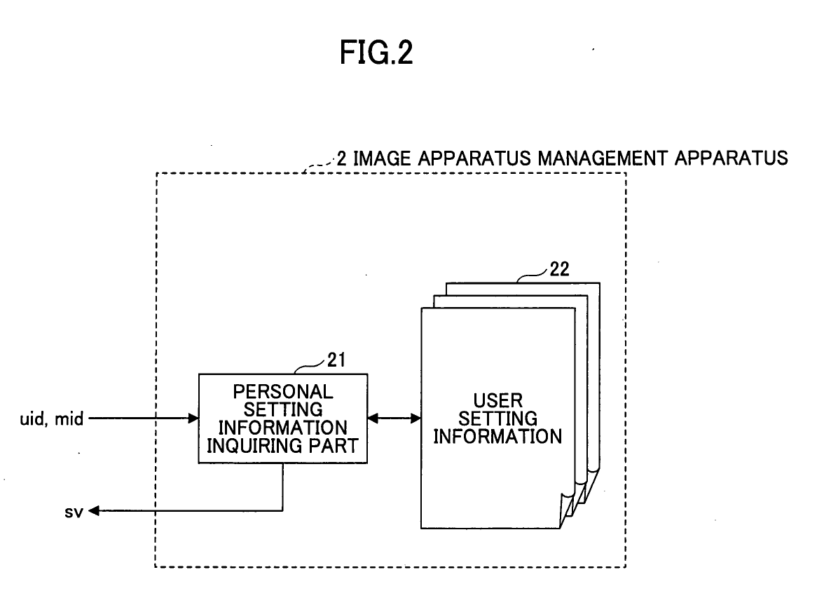

FIG. 2 depicts a configuration of the image apparatus management apparatus 2. As depicted in FIG. 2, in the image apparatus management apparatus 2, when the user ID (uid) and the machine ID (mid) are thus input, a personal setting information inquiring part 21 reads user setting information 22 held for each user and for each machine. As a result, the personal information inquiring part 21 reads user setting information 22 for the user, and extracts a toner save rate of the user who has been thus authenticated by the first authentication part 4 as mentioned above. Information sv indicating the thus-extracted toner save rate is then returned to the first image copying apparatus 3 from the image apparatus management apparatus 2. The first image copying apparatus 3 carries out toner save processing according to the toner save rate indicated by the information sv returned from the image apparatus management apparatus 2.

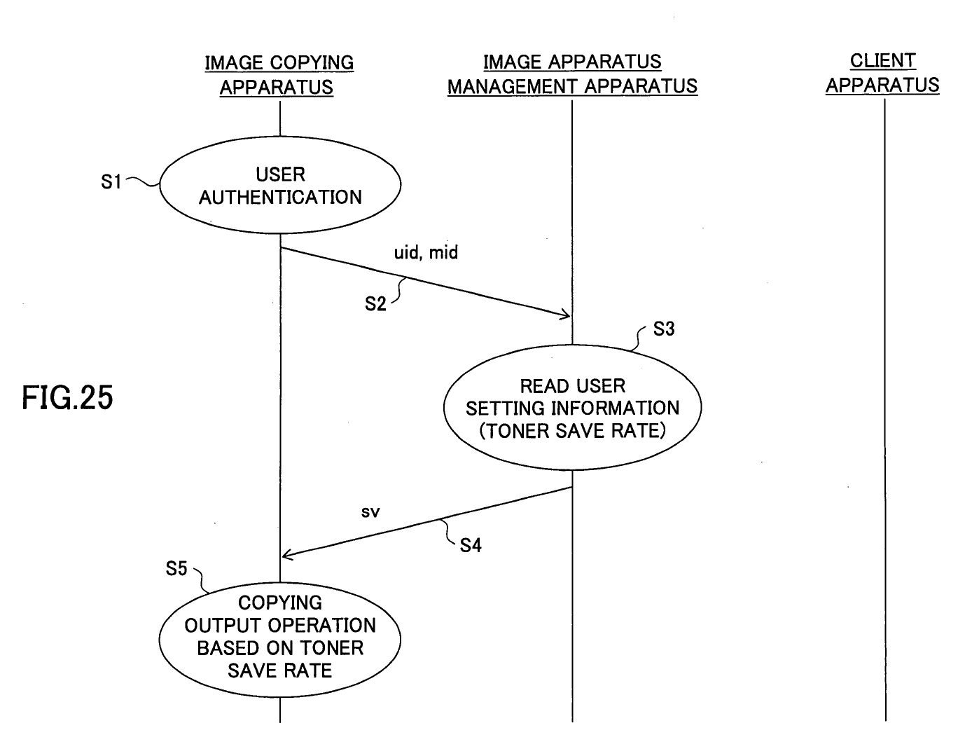

FIG. 25 depicts a flow of processing and a flow of data in the image forming apparatus management system in the first reference example. As depicted in FIG. 25, when a user wishes to carry out copying with the use of the first image copying apparatus 3, user authentication is carried out by the first user authentication part 4 provided in the first image copying apparatus 3 (Step S1). As a result of the user authentication, when it is confirmed by the first user authentication part 4 that the user is a user who is allowed to use the first image copying apparatus 3, the first image copying part 3 transmits a user ID (uid) of the user and a machine ID (mid) of the first image copying apparatus 3 (Step S2). The image apparatus management apparatus 2 then receives the user ID (uid) and the machine ID (mid), and the personal setting information inquiring part 21 reads a toner save rate which is used when the user uses the first image copying apparatus 3, from the user setting information 22 (Step S3). Information sv indicating the toner save rate thus read is then returned to the first image copying apparatus 3 by the image apparatus management apparatus 2 (Step S4). The first image copying apparatus 3 carries out a copying operation with the toner save rate indicated by the information sv (Step S5).

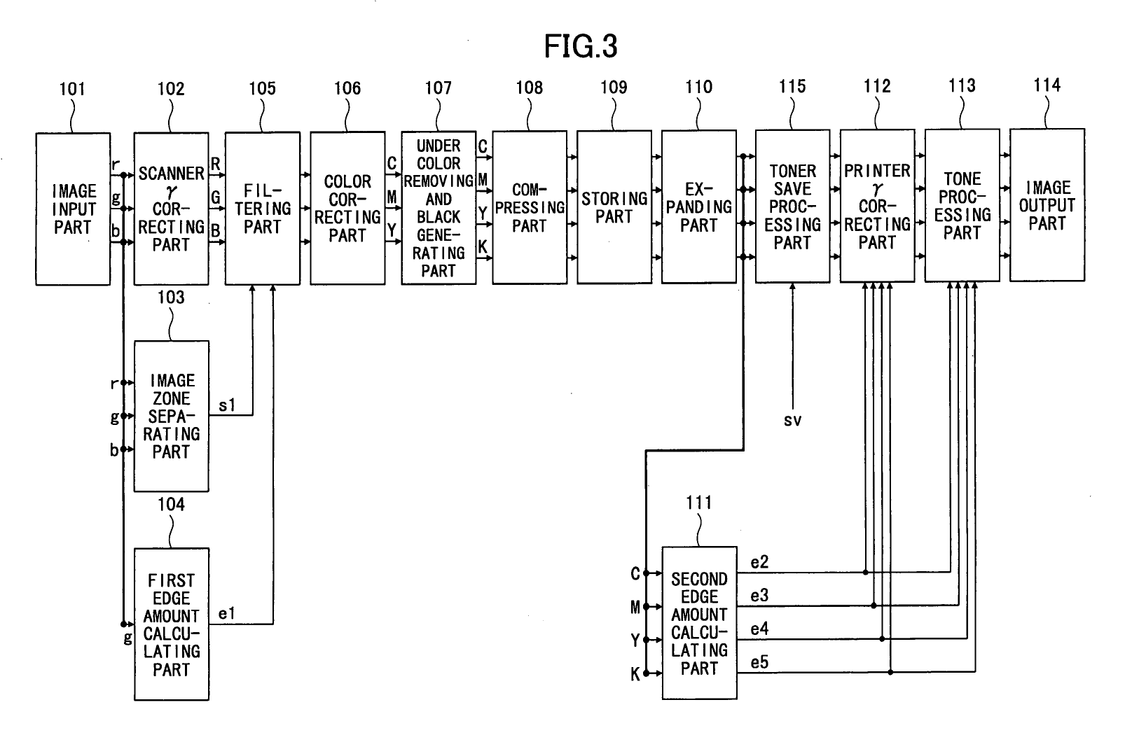

In order to illustrate the toner save processing in the first reference example, a general configuration of the first image copying apparatus 3 depicted in FIG. 1 will be described with reference to FIG. 3. In FIG. 3, an original image read optically by means of an image input part 101 such as a scanner is output in a form of digital signals r, g and b (i.e., red, green and blue) each having 8 bits converted from optical signals. The output image signals are input to a scanner γ correcting part 102, which converts the input image signals into image signals (referred to as R, G, B signals, hereinafter) which are linear to a tone level from the r, g, b image signals which are linear to reflectance, by means of a LUT (Look-Up Table) or such. Simultaneously, the r, g, b signals are input to an image zone separating part 103, which distinguishes a given image into a character zone and another zone. The other zone means a half-tone image zone (characters on half-tone dots are distinguished as a half-tone image zone), a continuous tone image zone or a background zone. Further, the g image signal is input to a first edge amount calculating part 104, which calculates an edge degree of the given image, and outputs it as an edge amount e1.

A filtering part 105 carries out adaptive edge enhancing processing or smoothing processing on the R, G, B signals based on the determination result of the image zone separating part 103 and the edge amount e1 of the first edge amount calculating part 104. The R, G, B signal thus processed are then output to a color correcting part 106. The color correcting part 106 converts the R, G, B signals into C, M, Y (i.e., Cyan, Magenta, Yellow) signals which are suitable to color materials in a printer system, by means of masking operation or such. The C, M, Y signals are then converted into a C, M, Y, K signals by an under color removing and black generating part 107, and the C, M, Y, K (i.e., Cyan, Magenta, Yellow, blacK) signals are output to a compressing part 108.

The compressing part 108 carries out data compressing processing on each of the C, M, Y, K signals according to a predetermined non-reversible compressing method, and are stored in a storing part 109 such as an image memory, a hard disk drive or such. The thus-stored compressed image signals are then expanded by means of an expanding part 110, and are output to a printer y correcting part 112 and a second edge amount calculating part 111.

The second edge amount calculating part 111 calculates edge amounts e2 through e5 by means of predetermined edge filters for respective ones of the C, M, Y, K signals, and the C, M, Y and K signals are then output to the printer y correcting part 112 and a tone processing part 113. The tone processing part 113 adaptively controls dither processing according to the edge amounts e2 through e5 in such a manner that both sharpness of character images and graininess/tone characteristics of half-tone image/continuous tone images can be obtained.

The printer γ correcting part 112 is controlled in conjunction with processing contents in the tone processing part 113. The printer γ correcting part 112 corrects tone characteristic differences caused by processing contents of the tone processing part 113, so that same tone reproduction characteristics can be obtained. Image signals thus processed by the tone processing part 113 are then output to an image outputting part 114 such as a laser printer, which then prints out the image signals on a recording medium such as recording paper, not shown.

Below, further details will be described. In the image zone separating part 103, a well-known image zone separating process is carried out. As a well-known image zone separating process, various methods are known. In the first reference example, for example, based on two detection results, i.e., an edge zone detection result and a half-tone zone detection result, image zone separating is carried out in a combining manner. In this method, characters on a white background are determined as a character zone, and half-tone images including characters on half-tone dots or continuous tone images are determined as a picture zone (i.e., a zone other than the character zone).

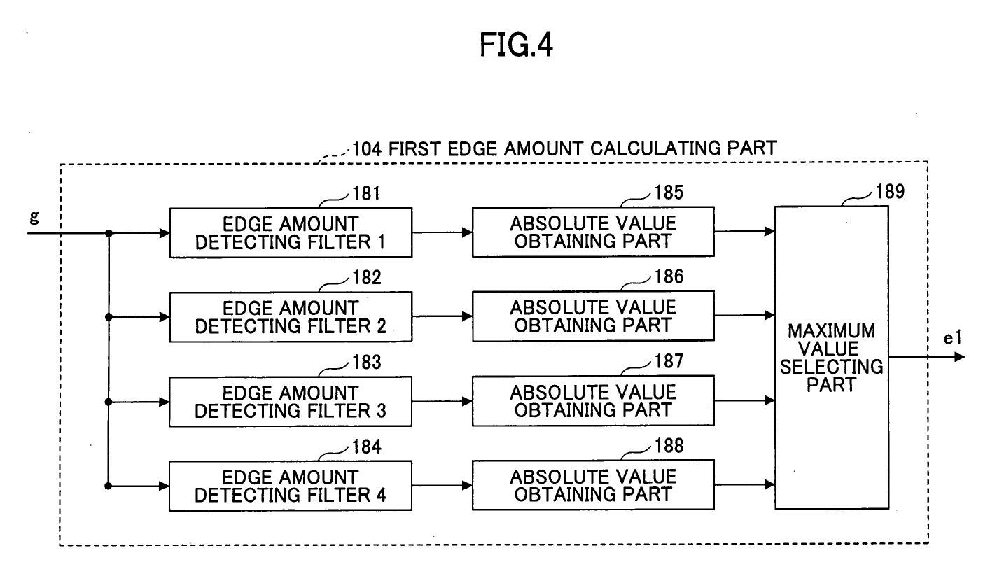

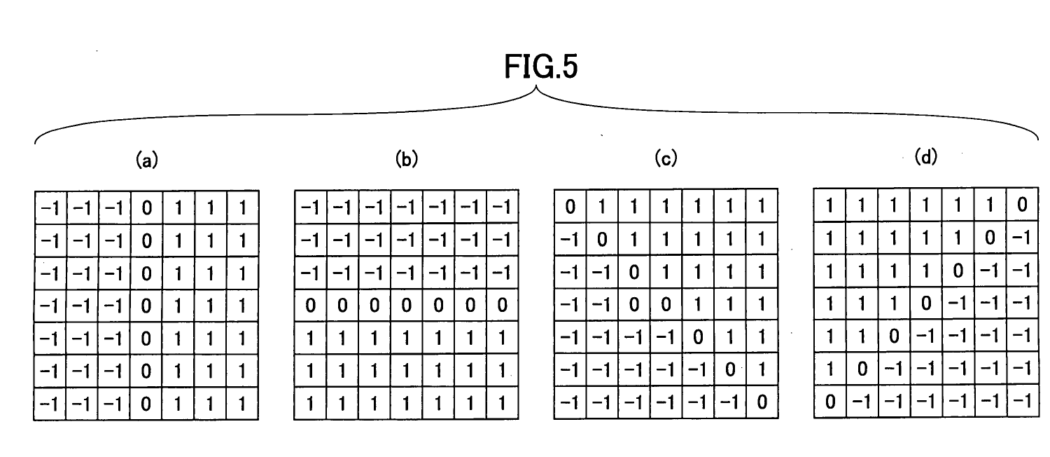

Next, operation of the first edge calculating part 104 will be described with reference to FIG. 4. The first edge amount calculating part 104 calculates an edge amount from the g signal obtained from the image input part 101. The g signal is input to four edge amount detecting filters 1-4 (181 through 184 in FIG. 4). The four edge amount detecting filters are first-order-differential filters each having a 7×7 matrix size, as depicted in FIG. 5, (a) through (d). These four edge amount detecting filters are used to detect a vertical edge, a horizontal edge, a left diagonal edge, and a right diagonal edge, respectively. Calculation results obtained from these edge amount detecting filters are input to absolute value obtaining parts 185 through 188, and thus, absolute values are obtained. Further, the maximum one of the thus-obtained four absolute values is selected by a maximum value selecting part 189, and is output as the edge amount e1.

Second-order-differential filters may be used instead of the above-mentioned first-order-differential filters. When second-order-differential filters are used, a high edge amount is detected from a central portion of a line. Therefore, it may be advantageous in edge enhancing processing. First-order-differential filters and second-order-differential filters may be combined, or a matrix size may be changed depending on each particular purpose.

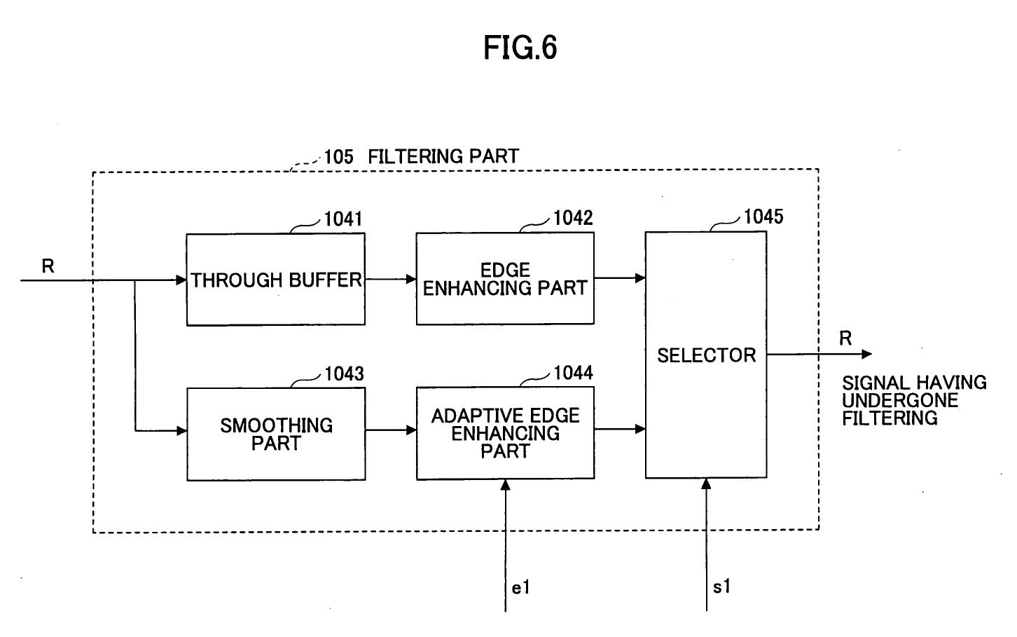

Next, operation of the filtering part 105 will be described with reference to FIG. 6. The filtering part 105 converts spatial frequency characteristics of given image signals having undergone processing by the scanner γ correcting part 102, based on a setting signal s1 (indicating a character zone or a picture zone) from the image zone separating part 103 and the edge amount e1 from the first edge amount calculating part 104. Description will be made only for the R signal of the R, G, B signals.

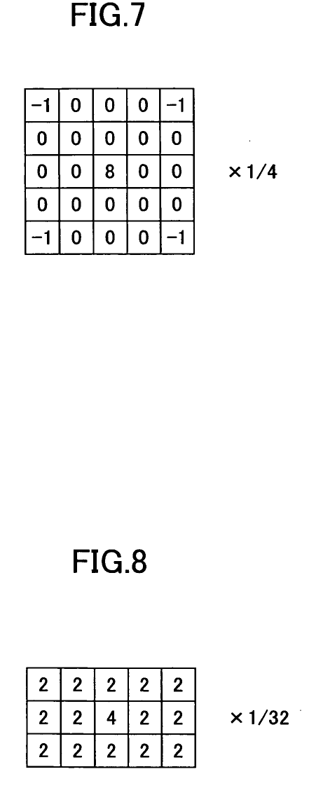

In FIG. 6, in a upper path, processing applied to a character zone is carried out. The image signal passes through a through buffer 1041, then undergoes uniform edge enhancing processing by an edge enhancing filer 1042, and is output to a selector 1045. Filter coefficients of the edge enhancing filer 1042 are such as those depicted in FIG. 7, which are designed in such a manner that sharpness of characters can be regarded as important. In a lower path, processing applied to a picture zone is carried out. The image signal is smoothed uniformly by means of a filter such as one depicted in FIG. 8 of a smoothing part 1043. After that, the image signal undergoes adaptive edge enhancing processing by an adaptive edge enhancing part 1044, where adaptive edge enhancing based on the edge amount e1 calculated as mentioned above is carried out.

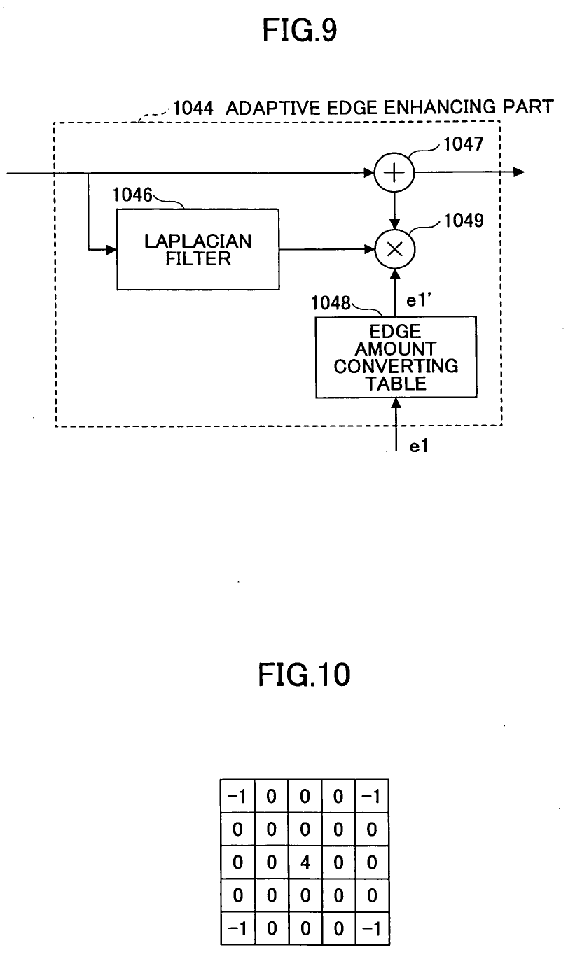

With reference to FIG. 9, the adaptive edge enhancing processing of the adaptive edge enhancing part 1044 will be described in more detail. The edge amount e1 obtained by the first edge amount calculating part 104 is input to an edge amount converting table 1048, and thus, is converted into an edge amount after correction e1′ by means of a predetermined converting table.

A Laplacian component is extracted from the image signal having undergone smoothing in the smoothing part 1043, by means of a Laplacian filter 1046 carrying out filtering as depicted in FIG. 10. After that, the Laplacian component is multiplied with the above-mentioned edge amount after correction e1′ by a multiplier 1049, and then, is added to the original image signal in an adder 1047.

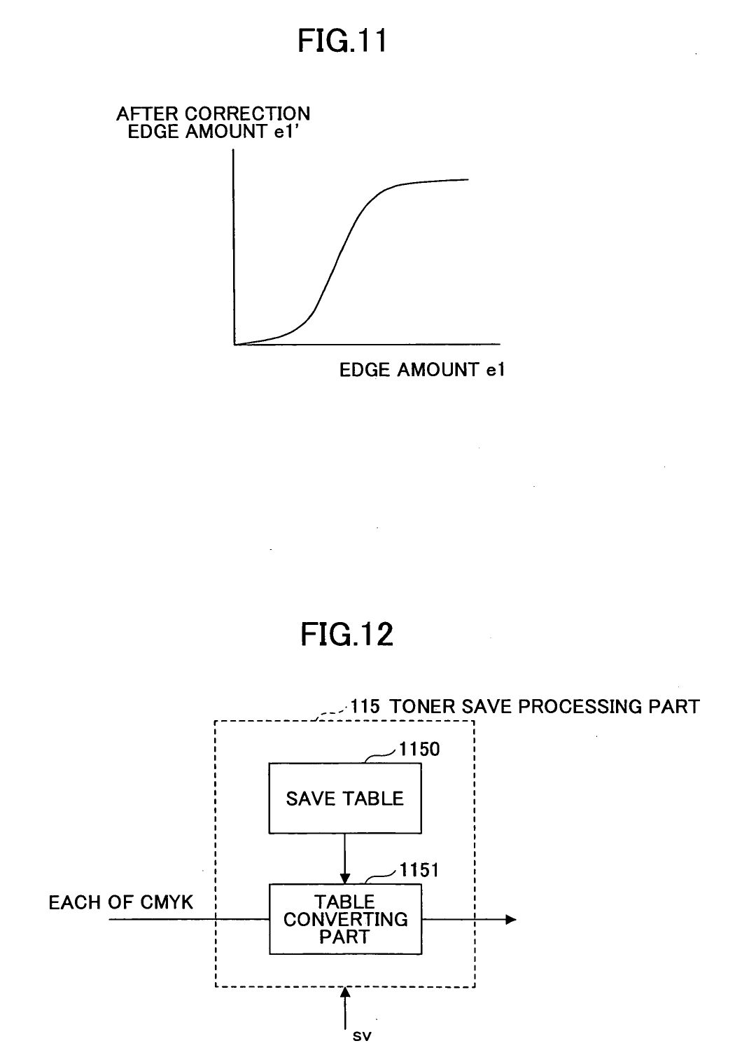

The above-mentioned edge converting table 1048 may preferably have such characteristics as those depicted in FIG. 11 for example that the edge amount after correction e1′ becomes smaller as the edge amount e1 becomes smaller. As a result, such a zone as a half-tone photograph zone, half-tone parts of background of characters, having the smaller edge amount e1 is corrected so that e1′ becomes more smaller, and weak edge enhancing is carried out. In contrast thereto, such a zone as characters in half-tone images having relatively the large edge amount e1 is corrected so that e1′ is further increased, and thus, stronger edge enhancing is carried out.

Returning to description of FIG. 6, the image signals thus having undergone the above-mentioned upper and lower paths are selectively output by the separating signal s1 from the image zone separating part 103.

Thereby, it is possible to carry out edge enhancing on characters on half-tone dots without enhancing half-tone parts, and thus, it is possible to improve both graininess in a picture zone and character sharpness.

Next, operation of the color correcting part 106 will be described. Various methods may be used for color correction. In the first reference example, masking calculation such as that expressed by the following formulas is used:

C=α11×R+α12×G+α13×B+β1

M=α21×R+α22×G+α23×B+β2

Y=α31×R+α32×G+α33×B+β3

It is noted that, a11 through α33 and β1 through β3 are color correction coefficients which are previously determined, and each of the signals C, M and Y which are output is a signal of 8 bits (i.e., 0 through 255).

Next, in the under color removing and black generating part 107, a black (K) signal is generated, and under color removal (UCR) is carried out from the C, M, Y signals. Specifically, processing expressed by the following formulas is carried out:

K=Min(C,M,Y)×34

C′=C−K×β5

M′=M−K×β5

Y′=Y−K×β5

It is noted that, Min(C, M, Y) means the minimum one of the C, M, Y signals. β4 and β5 are previously determined coefficients, and are signals each having 8 bits. The C, M, Y, K signals output from the under color removing and black generating part 107 undergo image compressing processing by means of the compressing part 108, and then, are stored by the storing part 109. The thus stored compressed image signals are expanded by the expanding part 110, and thereon, subsequent image processing is carried out. That is, when a copying request for a plurality of copies from a user via an operating part, not shown, is given, the compressed image signals stored in the storing part 109 are read a plurality of times for the plurality of copies, subsequent image processing are carried out on the thus-read image signals, and then, are output. It is noted that, C, M, Y, K signals after having undergone the under color removing and black generating part 197 are stored, in the first reference example. However, it is also possible that R, G, B signals before having undergone color correction may be stored.

The image signals from the expanding part 110 are input to the toner save processing part 115. As mentioned above, information sv indicating a toner save rate, which is provided by the image apparatus management apparatus 2 to the first image copying apparatus 3, is input to the toner save processing part 115. The toner save processing part 115 converts a pixel value, according to the toner save rate indicated by the information sv. FIG. 12 depicts a detailed configuration of the toner save processing part 115.

As depicted in FIG. 12, in the toner save processing part 115, a table converting part 1151 selects a converting table from a save table 1150 according to the information sv indicating the toner save rate. The thus-selected converting table is used to convert the image signals, and thus-converted image signals are output from the toner save processing part 115. In the first image copying apparatus 3, a circuit of the toner save processing part 115 depicted in FIG. 12 is provided for each of the C, M, Y, K signals. Thus, a total of four circuits of the toner save processing parts 115 are provided in the first image copying apparatus 3.

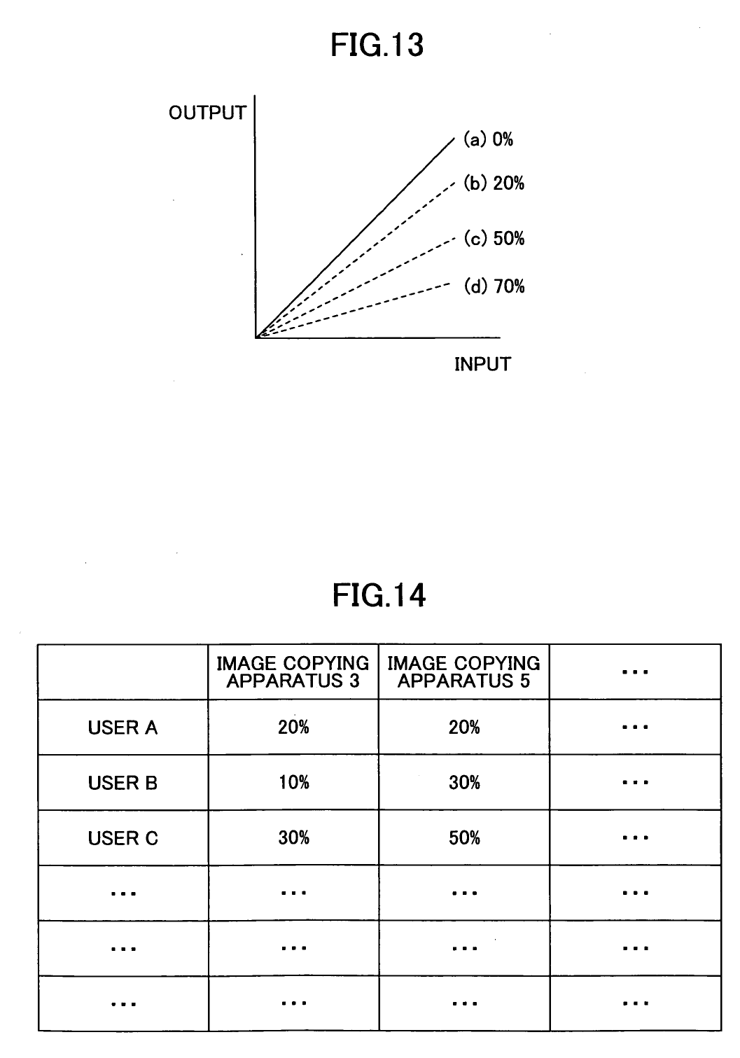

The save table 1150 includes a plurality of converting tables having characteristics depicted in FIG. 13. Each of the plurality of converting tables is used to convert a pixel value indicated by each of C, M, Y, K signals into a smaller pixel value. For example, a converting table of FIG. 13, (b), is for a toner save rate of 20%, and a converting table of FIG. 13, (c), is for a toner save rate of 50%. A converting table of FIG. 13, (a), is for a toner save rate of 0%. That is, according to the converting table of FIG. 13, (a), an original pixel value is output as it is.

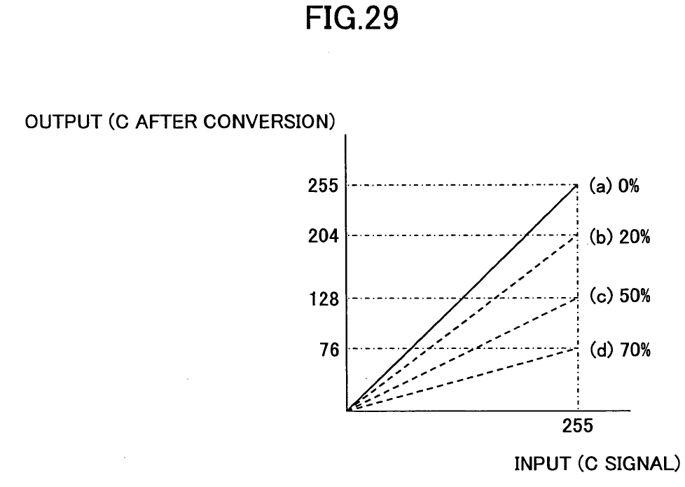

FIG. 29 illustrates the save table 1150 more specifically. Each of the plurality of converting tables is used to convert each of C, M, Y, K signals (each is of 8-bit signal) obtained from the above-mentioned under color removing and black generating processing. FIG. 29 depicts an example of a C signal. The same converting processing is carried out also on each of the other M, Y, K signals. In FIG. 29, an abscissa axis denotes a pixel value of the C signal input to the toner save processing part 115. An ordinate axis in FIG. 29 denotes a pixel value of the C signal output from the toner save processing part 115, and thus, a pixel value of the C signal after conversion (i.e., after undergoing the toner save processing). The same as in the case of FIG. 13, FIG. 29, (b) denotes an example of a toner save rate of 20%, and (c) denotes an example of a toner save rate of 50%. FIG. 29, (a), denotes a toner save rate of 0%. That is, according to the converting table of FIG. 29, (a), an original pixel value is output as it is.

When the converting table of the toner save rate of 20% depicted in FIG. 29, (b), is used, a pixel value 255 is converted into a pixel value of 204, as depicted in FIG. 29, (b). Converting characteristics depicted in FIG. 29 can be expressed by the above-mentioned formula (I) (also depicted below) for obtaining a pixel value after undergoing toner save processing from a pixel value before undergoing the toner save processing:

(pixel value after toner save processing)=(pixel value before toner save processing)×(100−“toner save rate [%]”)/100 (1)

Each converting table included in the save table 1150 is one which previously stored in the save table 1150 through the following process: Previously, calculation results obtained from the above-mentioned formula (1) are stored in such a comparative table form that specific pixel values after undergoing toner save processing can be obtained from specific pixel values before undergoing toner save processing, respectively.

Therefore, in a case of the toner save rate of 20% of FIG. 29, (b), a pixel value after toner save processing, that is, after conversion with the converting table, is obtained from the following calculation:

255×(100−20)/100=204

As a result, a tone reduces, and thus, a toner amount used in the image outputting part 114 reduces accordingly. Thus, toner is saved. Similarly, in a case of the toner save rate of 50% of FIG. 29, (c), a pixel value after toner save processing, that is, after conversion with the converting table, is obtained from the following calculation:

255×(100−50)/100=127.5≈128

As a result, a tone further reduces, and thus, a toner amount used in the image outputting part 114 further reduces accordingly.

Since C, M, Y, K signals express respective tones, it is possible to easily carry out tone conversion with the use of linear conversion characteristics such as those depicted in FIG. 29. Output characteristics in an image forming engine included in the image output part 114 are corrected by the printer γ correcting part 112 described above. Therefore, linear conversion characteristics such as those mentioned above can be used.

FIG. 14 depicts information of a table of toner save rates included in the user setting information 22 (see FIG. 2) which the image apparatus management apparatus 2 has. Information sv indicating a toner save rate written in the table is transmitted to the first image copying apparatus 3. In the table of toner save rates depicted in FIG. 14, the top line depicts toner save rates prescribed for a user A, a next line depicts toner save rates prescribed for a user B, and a further next line depicts toner save rates prescribed for a user C. Further, in the table of toner save rates depicted in FIG. 14, a leftmost column depicts toner save rates prescribed for the first image copying apparatus 3, and a next column depicts toner save rates prescribed for the second image copying apparatus 5. For example, when the user A wishes to use the first image copying apparatus 3, in Step S2 of FIG. 25, a user ID (uid) of the user A and a machine ID (mid) of the first image copying apparatus 3 are transmitted to the image apparatus management apparatus 2. In response to the information uid and mid, the image apparatus management apparatus 2 searches the table of FIG. 14 (Step S3). As depicted in FIG. 14, a toner save rate prescribed for both user A and first image copying apparatus 3 is a toner save rate of 20%. Therefore, the image apparatus management apparatus 2 extracts the toner save rate of 20% from the table. The image apparatus management apparatus 2 then transmits information sv indicating the toner save rate of 20% to the first image copying apparatus 3 (Step S4) such that, a converting table of the toner save rate of 20% is designated which is included in the plurality of converting tables stored in the save table 1150 of the first image copying apparatus 3.

Returning to the description of FIG. 3, the image signals from the expanding part 110 are input to a second edge amount calculating part 111, which calculates edge amounts again. As a specific method of calculating edge amounts, the same as that of the first edge amount calculating part 104 is used. The first edge amount calculating part 104 calculates an edge amount of the g signal. The second edge amount calculating part 111 calculates an edge amount separately for each of given C, M, Y, K signals. Thus-obtained edge amounts e2 through e5, are input to the printer γ correcting part 112 and the tone processing part 113.

The printer γ correcting part 112 and the tone processing part 113 control their characteristics and processing continuously according to the edge amounts obtained by the second edge amount calculating part 111, to realize high-quality image reproduction. In adaptive dither processing according to the edge amounts carried out by the tone processing part 113, some basic dither tables are previously held, a predetermined dither table is selected therefrom based on the input edge amounts, and a dither threshold is calculated from interpolation calculation based on the selected dither table and the edge amounts, for example.

The edge amounts e2 through e5 are input to the tone processing part 113 which carries out continuous control based on the edge amounts e2 through e5, and the tone processing apparatus 113 carries out tone processing. As a result, high-quality image reproduction without defects is realized.

Control operation carried out by the printer γ correcting part 112 is carried out in conjunction with control operation carried out by the tone processing part 113. As a result, the printer γ correcting part 112 corrects tone characteristics (i.e., printer's raw γ characteristics) occurring due to a difference in the tone processing way, and it is possible to obtain uniform output tone characteristics.

In the correcting processing carried out by the printer γ correcting part 112, the same as in the case of determining the dither threshold and carrying out dither processing described above, some basic printer γ tables are previously held, a predetermined printer γ table is selected based on the input edge amounts, and interpolation calculation is carried out based on the selected printer y table and the edge amounts. As a result, correcting characteristics in the printer γ correcting part 112 are determined. Thereby, it is possible to continuously determine the printer γ correcting characteristics with respect to the edge amounts which are obtained as continuous values.

As described above, information sv indicating a toner save rate is transmitted to the first image copying apparatus 3 from the image apparatus management apparatus 2. The first image copying apparatus 3 having received the information sv carries out toner save processing according to the toner save rate indicated by the information sv. As a result, it is possible to carry out copying in which a toner using amount is reduced accordingly.

### Variant Example of First Reference Example

A variant example of the first reference example described above will now be described. In the variant example of the first reference example, an edge of an image to be output is detected, and toner save processing is carried out according to the detection result. The variant example of the first reference example has the same configuration and functions as those of the first reference example described above except for the above-mentioned point in the toner save processing.

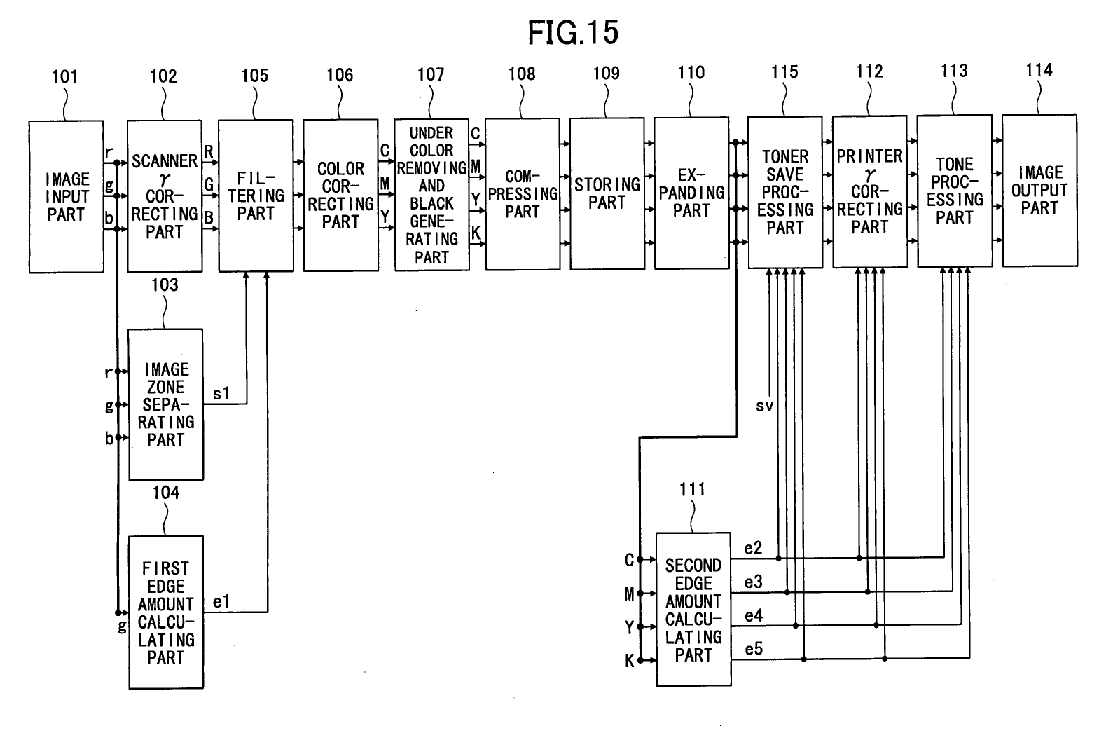

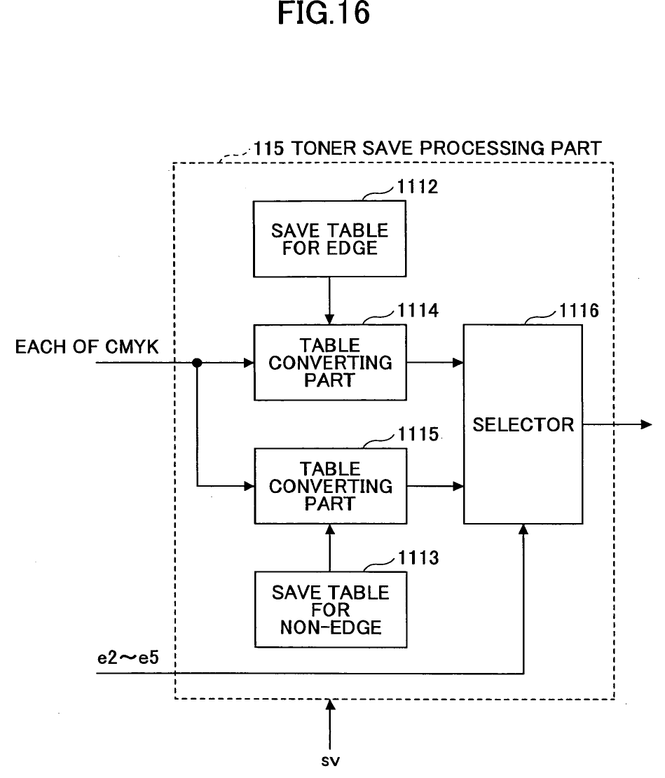

The first image copying apparatus 3 in the first reference example mentioned above reduces a toner using amount uniformly throughout the entirety of an image processed. In contrast thereto, according to the variant example of the first reference example, in order to improve visibility of characters and line drawings included in an image processed, image zones are detected, and a toner save rate is determined separately for each of the thus-detected image zones. More specifically, based on an edge detection result, a smaller toner save amount is set for an edge part of an image processed, while, a larger save amount is set for a non-edge part of the image processed. As a result, even when toner save processing is carried out, it is possible to ensure visuality in characters having edge parts of an image processed. FIG. 15 depicts a configuration of the first image copying apparatus 3 in the case of the variant example of the first reference example.

The variant example of the first reference example depicted in FIG. 15 is the same as the first reference example depicted in FIG. 3, except for a configuration of the toner save processing part 115. In the toner save processing part 115 of FIG. 15, not only information sv indicating a toner save rate, transmitted from the image apparatus management apparatus 2, edge amounts e2 through e5 from the second edge amount calculated part 111 are input. FIG. 16 depicts the toner save processing part 115 in the variant example of the first reference example.

As depicted in FIG. 16, for pixel values of input C, M, Y, K signals, two table converting parts 1114 and 1115 are provided, and either one of the two table converting parts 1114 and 1115 is selected by a selector 1116 for a corresponding one of different image zones. The table converting part 1114 responds to information sv indicating a toner save rate, to select a converting table from an edge toner save table 1112. Similarly, the table converting part 1115 responds to information sv indicating a toner save rate, to select a converting table from a non-edge toner save table 1113.

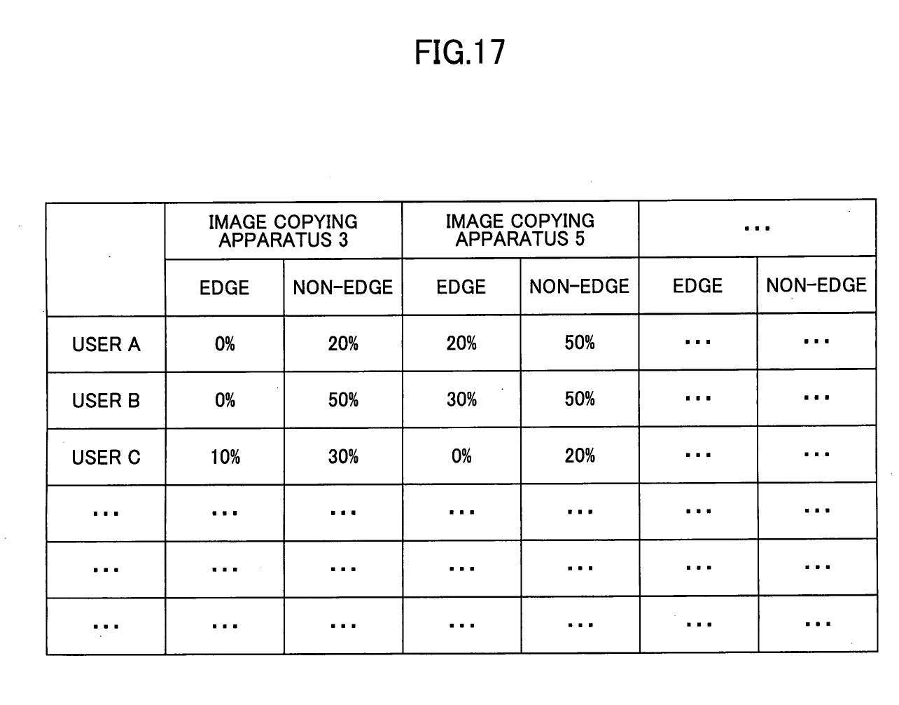

In the variant example of the first reference example, a table of toner save rates included in user setting information 22 which the image apparatus management apparatus 2 has is a table of toner save rates depicted in FIG. 17, which is different from the table of toner save rates depicted in FIG. 14 mentioned above. In the table of the toner save rates depicted in FIG. 17, the top line depicts toner save rates prescribed for a user A, a next line depicts toner save rates prescribed for a user B, and a further next line depicts toner save rates prescribed for a user C. Further, in the table of toner save rates depicted in FIG. 14, a leftmost column depicts toner save rates prescribed for the first image copying apparatus 3, and also, prescribed for an edge part of an image processed. A next column depicts toner save rates prescribed for the first image copying apparatus 3, and also, prescribed for a non-edge part of an image processed. A further next column depicts toner save rates prescribed for the second image copying apparatus 5, and also, prescribed for an edge part of an image processed. A further next column depicts toner save rates prescribed for the second image copying apparatus 5, and also, prescribed for a non-edge part of an image processed.

For example, when the user A wishes to use the first image copying apparatus 3, in Step S2 of FIG. 25, a user ID (uid) of the user A and a machine ID (mid) of the first image copying apparatus 3 are transmitted to the image apparatus management apparatus 2 (Step S2). In response to the information uid and mid, the image apparatus management apparatus 2 searches the table of FIG. 17 (Step S3). As depicted in FIG. 17, a toner save rate prescribed for both user A and first image copying apparatus 3 is a toner save rate of 0% for an edge part and 20% for a non-edge part of an image processed. Therefore, the image apparatus management apparatus 2 extracts the toner save rate of 0% for an edge part and 20% for a non-edge part of an image processed from the table. The image apparatus management apparatus 2 then transmits information sv indicating the toner save rate of 0% for an edge part of an image processed and information sv indicating a toner save rate of 20% for a non-edge part of an image processed (Step S4)

Thereby, it is possible to realize the image forming apparatus management system in which, a server, i.e., the image apparatus management apparatus 2, can collectively manage the plurality of image copying apparatuses 3 and 5 each having the function of copying with toner save processing in the copying and also with improved visibility of characters of an image processed.

Thus, also in the variant example of the first reference example, the first image copying apparatus 3 carries out user authentication for each user upon copying (Step S1 of FIG. 25), and inquires the image apparatus management apparatus 2 (i.e., management server) of a toner save rate (Step S2). As a result, the image apparatus management apparatus 2 transfers information sv indicating the toner save rate which is previously set in the image apparatus management apparatus 2, to the first image copying apparatus 3 (Step S4). The first image copying apparatus 3 carries out image forming based on the toner save rate indicated by the received information sv (Step S5). As a result, a manager can manages, with the use of the image apparatus management apparatus 2, toner use conditions for each of users who use the first image copying apparatus, collectively.

### Second Reference Example

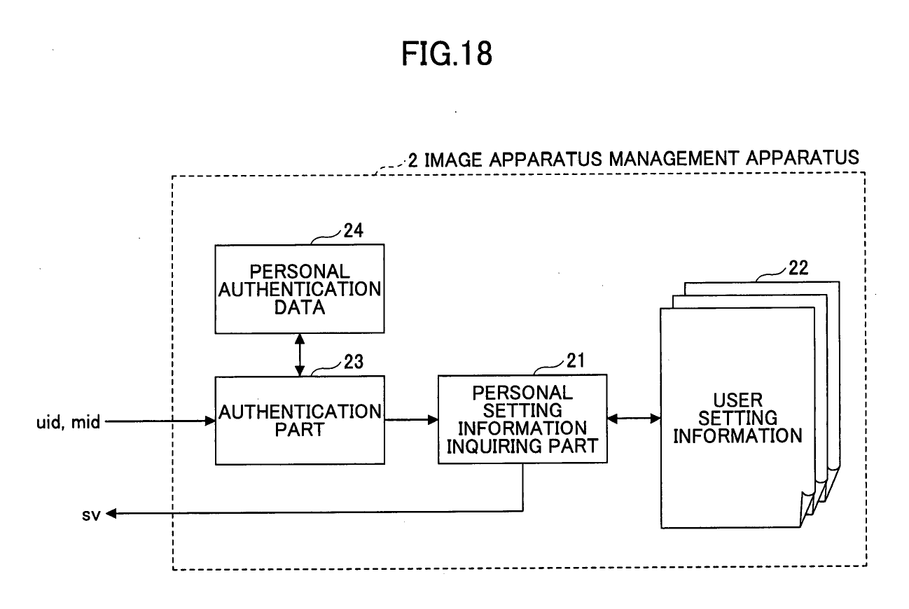

In the above-described first reference example and the variant example of the first reference example, the first authentication part 4 of the first image copying apparatus 3 carries out user authentication. In contrast thereto, in an image forming apparatus management system in a second reference example, as depicted in FIG. 18, the image apparatus management apparatus 2 has a user authentication part 23. In the second reference example, as a device for inputting user information from a user, the second reading part 6 of the second image copying apparatus 5 depicted in FIG. 2 is used. In the second reference example, the first image copying apparatus 3 and the second image copying apparatus 5, depicted in FIG. 1, are managed by the image apparatus management apparatus 2. Thus, the image forming apparatus management system in the second reference example has a configuration the same as that of the first reference example depicted in FIG. 1.

In the second reference example, in the image forming apparatus management system depicted in FIG. 1, the second user reading part 6 reads ID information (uid) from a user ID which has been input by a user from the second user reading part 6. The second image copying apparatus 5 transmits the ID information (uid, which is also referred as a user ID (uid)), read by the second user reading part 6, and a machine ID (mid) of the second image copying apparatus 5, to the image apparatus management apparatus 2, via the communication network 1. In the image apparatus management apparatus 2 which has received the information uid and mid, the authentication part 23 depicted in FIG. 18 compares the uid with personal authentication data 24, and determines whether a corresponding user is allowed to use the second image copying apparatus 5. When it is determined that the corresponding user is allowed to use the second image copying apparatus 5, the authentication part 23 transfers, to a personal information inquiring part 21, the user ID (uid) which has been thus authenticated by the authentication part 23, and the machine ID (mid). The personal information inquiring part 21 receives the information uid and mid, and searches user setting information 22 which is previously set and held.

The user setting information 22 is information which is previously set for each of users who use machines, i.e., image copying apparatuses. The user setting information 22 is held for each machine. The user setting information 22 includes a table of toner save rates. The table of toner save rates is, for example, the same as the table of toner save rates in the first reference example, depicted in FIG. 14, or the table of toner save rates in the variant example of the first reference example, depicted in FIG. 17. In the same operation as that described above for the first reference example or the variant example of the first reference example, the image apparatus management apparatus 2 extracts a toner save rate or toner save rates from the table of toner save rates, and transmits information sv indicating the toner save rate or the toner save rates to the second image copying apparatus 5.

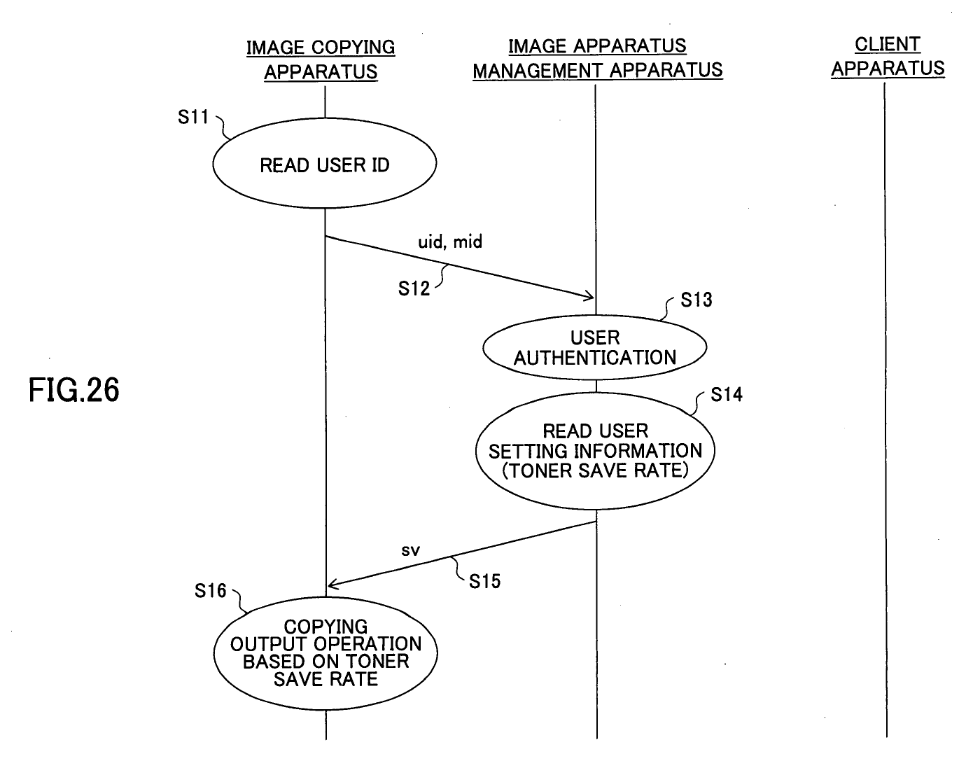

FIG. 26 depicts a flow of processing and a flow of data in the image forming apparatus management system in the second reference example.

As depicted in FIG. 26, when a user wishes to carry out copying with the use of the second image copying apparatus 5, the second user reading part 6 provided in the second image copying apparatus 5 reads a user ID of the user (Step S1). At this timing, no user authentication as to whether the user is allowed to use the second copying apparatus is carried out. Next, the second image copying apparatus 5 transmits the user ID (uid) and a machine ID (mid) of the second image copying apparatus 5, to the image apparatus management apparatus 2 (Step S12). The image apparatus management apparatus 2 receives the information (uid and mid), and carries out the user authentication in the authentication part 23 (Step S13). When it is determined as a result of the user authentication that the user is allowed to use the second image e copying apparatus 5, the personal setting information inquiring part 21 extracts a toner save rate to be used when the user uses the second image copying apparatus 5, from the user setting information 22 (Step S14). The image apparatus management apparatus 2 returns information sv indicating the extracted toner save rate, to the second image copying apparatus 5 (Step S15). The second image copying apparatus 2 carries out copying with the toner save rate indicated by the received information sv (Step S16).

It is noted that, although not actually depicted in FIG. 26, when it is determined as a result of the user authentication that the user is not allowed to use the second image copying apparatus 5, the image apparatus management apparatus 2 returns to the second image copying apparatus 5 a notification indicating that the user is not allowed to use the second image copying apparatus 5.

Thus, in the second reference example, the server (i.e., the image apparatus management apparatus 2) itself carries out user authentication. Thereby, it is also possible to manage setting of user authentication collectively from the server.

### Third Reference Example

A third reference example will now be described with reference to FIG. 1.

As depicted in FIG. 1, an office may have the plurality of image copying apparatuses 3 and 5. In such a case, a user may use any one of the plurality of image copying apparatuses 3 and 5. In the third reference example, in such a case, management of toner save rates for respective users can be carried out.

In a case where a user uses the first image copying apparatus 3 to copy an image and also, in a case where a user uses the second image copying apparatus 5 to copy an image, information concerning toner save rates of authenticated users is collectively managed by the image apparatus management apparatus 2. Information sv indicating toner save rates is transmitted at any time only from the image apparatus management apparatus 2. As a result, management of toner save rates can be carried out even when any one of the plurality of image copying apparatuses is used to copy an image. Therefore, toner save rates can be collectively managed for a plurality of image copying apparatuses provided in an office, for example, even when any one of the plurality of image copying apparatuses is used.

For example, according to the table of toner save rates depicted in FIG. 14, when the user B uses the first image copying apparatus 3, control is made such that copying with the use of the first image copying apparatus 3 can be carried out with the toner save rate of 10% according to the table. Similarly, when the user B uses the first image copying apparatus 5, control is made such that copying an image with the use of the second image copying apparatus 5 can be carried out with the toner save rate of 30% according to the table. Thus, the image apparatus management apparatus 2 holds toner save rates for the plurality of image copying apparatuses.

It is noted that toner save rates for respective machines (i.e., first and second image copying apparatuses 3 and 5) can be freely set. For example, in a case where the first image copying apparatus 3 is a color copier, and the second image copying apparatus 5 is a monochrome copier, setting may be made such that, for the color copier, for which toner costs are higher, higher toner save rates (whereby toner can be saved more) may be set, than those of the monochrome copier, accordingly. In another case, any machine may be set as a machine in particular for trial copying and another machine may be set as a machine in particular for final copying, and, in such a case, higher toner save rates may be set for the machine for trail copying.

### First Embodiment

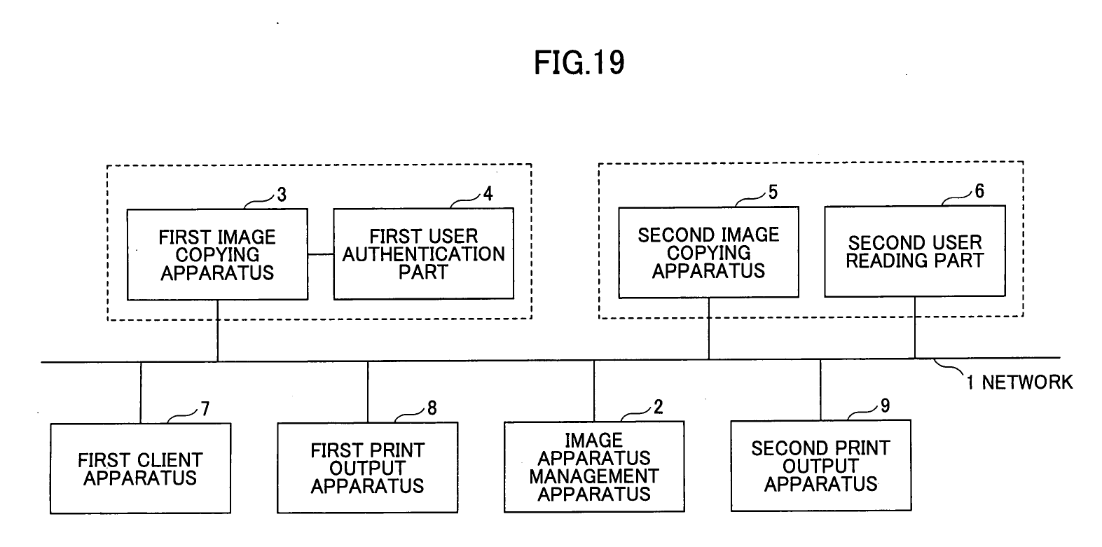

FIG. 19 depicts an image forming apparatus management system in a first embodiment.

In a configuration of FIG. 19, in addition to the configuration of FIG. 1 described above, a first client apparatus 1, a first print output apparatus 8 (for example, a printer) and a second print output apparatus 9 (for example, another printer) are connected to the communication network 1.

In the configuration of FIG. 19, when, in the first client apparatus 7 (for example, a personal computer), a user logs in, the user is authenticated as to who is the user, and a corresponding user ID is obtained therefrom. A case is assumed where the user wishes to print out a document created in the first client apparatus 7, with the use of the first print output apparatus 8. For this purpose, the first client apparatus 7 issues a print command in response to the user making a print output request on the first client apparatus 7. The first print output apparatus 8 having received the print command, transmits the user ID of the user who originally made the print output request on the first client apparatus 7, to the image apparatus management apparatus 2 to inquire the image apparatus management apparatus 2 of information sv indicating a toner save rate. The image apparatus management apparatus 2 then obtains a toner save rate from user setting information 22 which stores set information for each user for print output, and returns the information sv indicating the toner save rate, to the first print output apparatus 8. The first print output apparatus 8 having received the information sv carries out the print command with carrying out toner save processing based on the toner save rate indicated by the received information sv, to print out the document.

It is noted that, throughout the specification, each of both terms of “printing out” and “print output” means printing out of data created, for example with the use of a computer or such, onto a paper medium or such, for example by means of a printer or such. The term “copying” means photocopy to read an original image, for example by means of a scanner part of a copier or such, and then, based on the read image, form an image onto a paper medium or such, for example by means of the copier or such.

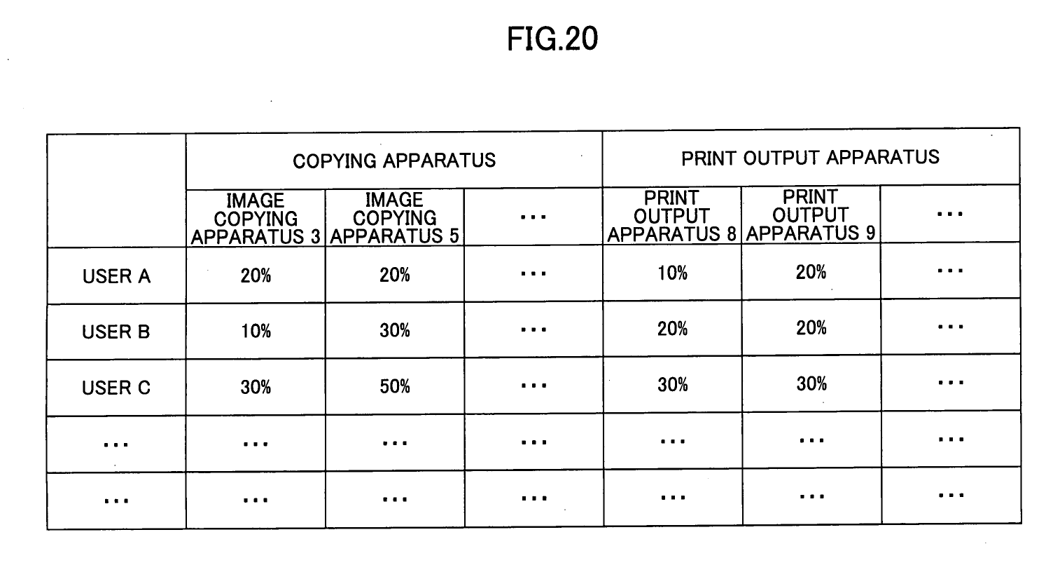

FIG. 20 depicts a table of toner save rates included in the user setting information 22 of the image apparatus management apparatus 2 in the first embodiment. As depicted in FIG. 20, the table of toner save rates stores toner save rates for each of users A, B, C, . . . , and also, for each of print output apparatuses, i.e., the first print output apparatus 8, the second print output apparatus 9, . . . . Therefore, for example, when a user A issues a print output request for the first print output apparatus 8, a toner save rate of 10% is extracted from the table of toner save rates of FIG. 20, a line of the user A (i.e., the top line), and a column of the first print output apparatus 8 (i.e., the left most column of “print output apparatus”). Information sv of the extracted toner save rate of 10% is then transmitted from the image apparatus management apparatus 2 to the first print output apparatus 8. In the image forming apparatus management system in the first embodiment, the table of toner save rates included in the user setting information 22 of the image apparatus management apparatus 2 also includes, as depicted in FIG. 20, toner save rates for the above-mentioned image copying apparatuses, i.e., the first image coping apparatus 3, the second image copying apparatus 5, . . . . Therefore, for each user, in a case where the user carries out copying (with the use of any one of image copying apparatuses 3, 5, . . . ) and also in a case where the user carries out print output (with the use of any one of print output apparatuses 8, 9, . . . ), management can be carried out collectively with the use of the table of toner save rates depicted in FIG. 20.

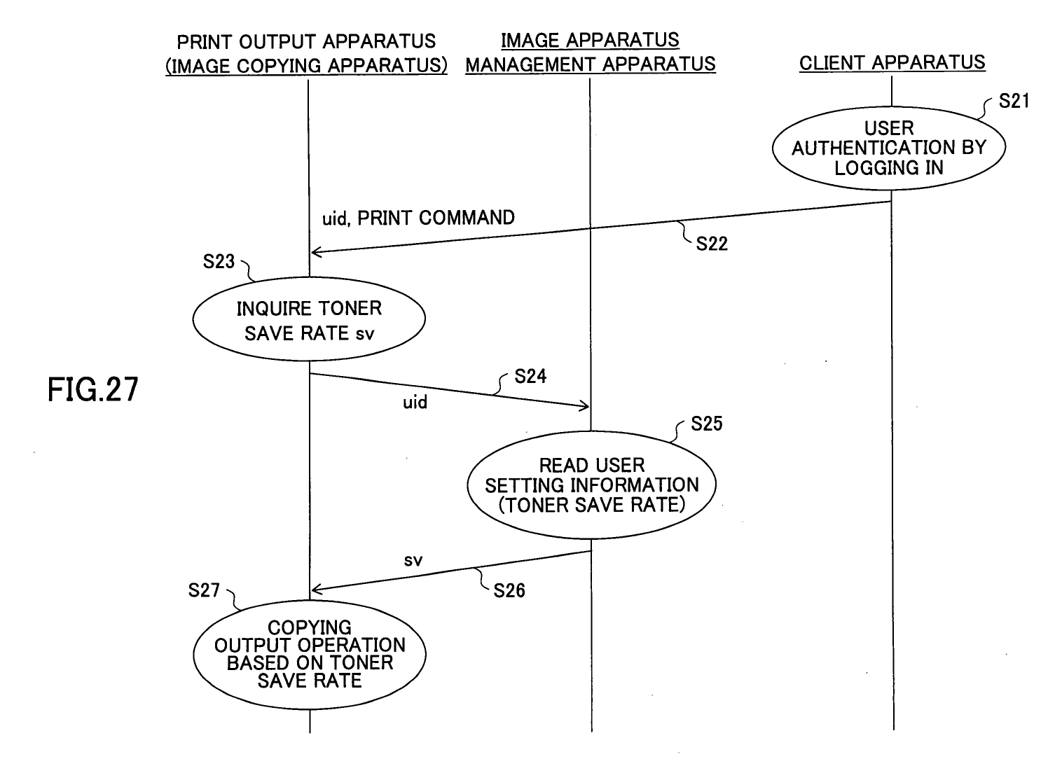

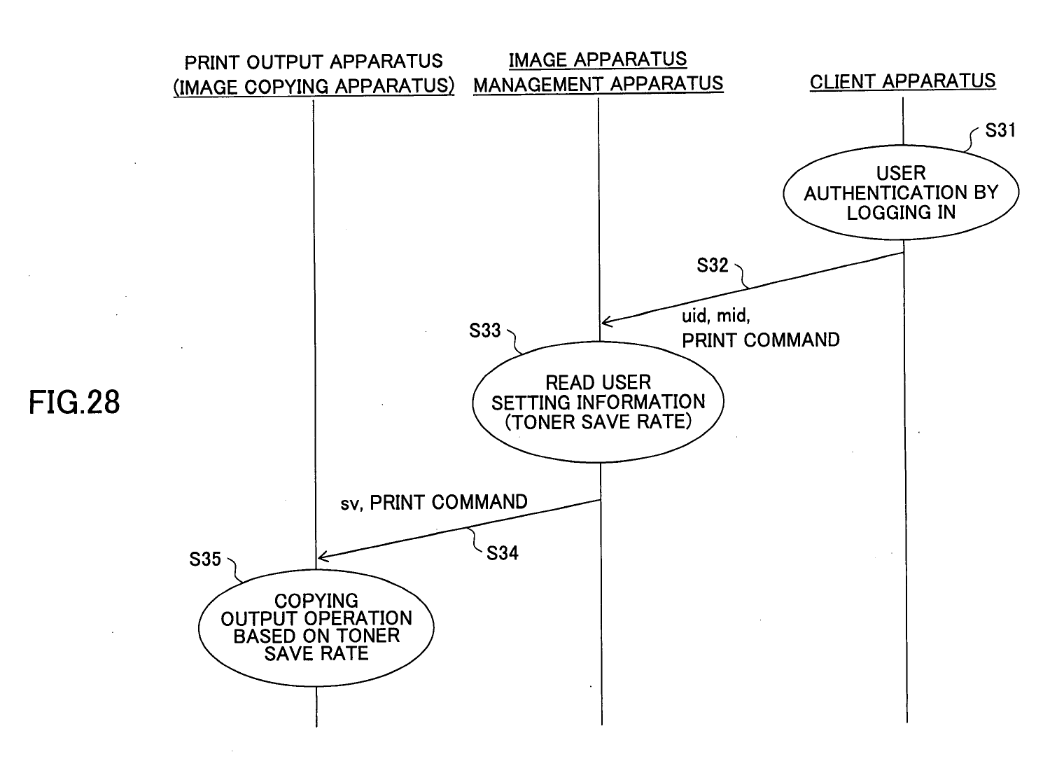

That is, in the image forming apparatus management system in the first embodiment, the above-described functions of the first reference example, the above-described functions of the variant example of the first reference example and the above-described functions of the second reference example, described above with reference to FIGS. 1-18, are included. Therefore, according to the first embodiment, in a configuration in which, as depicted in FIG. 19, the first image copying apparatus 3, the second image copying apparatus 5, the first client apparatus 7, the first print output apparatus 8, the image apparatus management apparatus 2 and the second print output apparatus 9 are mutually connected via the communication network 1, when a user uses the first image copying apparatus 3 having the first user authentication part 4 to carry out copying, operation such as that depicted with reference to FIG. 25 in the first reference example or the variant example of the first reference example is carried out. On the other hand, when a user uses the second image copying apparatus 5 having the second user reading part 6 to carry out copying, operation such as that depicted with reference to FIG. 26 in the second reference example is carried out. Further, when a user carries out printing out with the use of the first user print output apparatus 8, operation described later with reference to FIG. 27 or FIG. 28 is carried out.

The print output apparatuses 8 and 9 may carry out, in a first case, toner save processing, with the use of a uniform toner save rate throughout all object types, and in a second case, the print output apparatuses 8 and 9 may carry out toner save processing with the use of a different save rate for each of respective object types. In the first case, toner used for the entire image are uniformly reduced to save a toner consumption amount. In the second case, smaller toner save rates are set for character objects and line objects of an image processed, while, larger toner save rates are set for other image objects and fill objects of the image processed. As a result, in the second case, it is possible to ensure visibility of characters and lines of the image processed even when toner save processing is carried out in printing out operation.

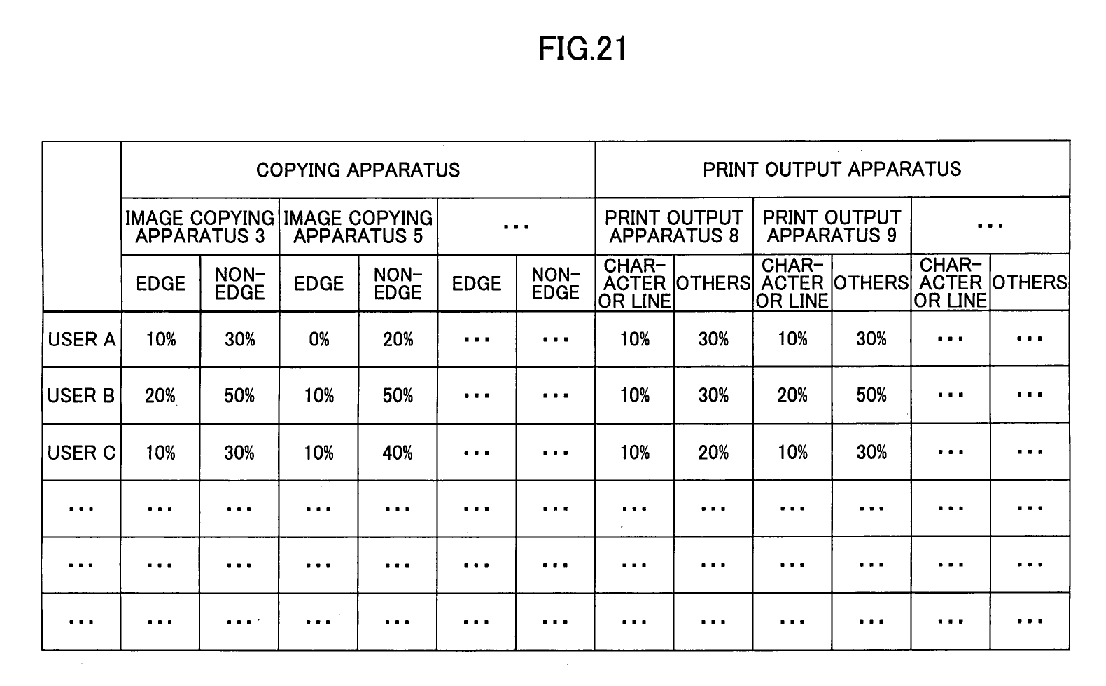

In the above-mentioned first case, the table of toner save rates depicted in FIG. 20 may be used in the image forming apparatus management system having the print output apparatuses 8 and 9. On the other hand, in the second case, i.e., in the image forming apparatus management system, regarding visibility of characters as important, as depicted in FIG. 21, a table of toner save rates, in which, toner save rates for “charters/lines” and toner save rates for “other” objects of an image processed are separately set, is used. Therefore, in a case where copying is carried out with the use of the image copying apparatuses 3 and 5, and also, in a case where printing out is carried out with the use of the print out apparatuses 8 and 9, toner save rates in an office can be collectively managed. Also, for a case of copying and also for a case of printing out, toner save processing with improving visibility of characters can be carried out in the same manner.

FIG. 27 depicts a processing flow and a data flow for when the first print output apparatus 8 is used in the image forming apparatus management apparatus in the first embodiment.

As depicted in FIG. 27, it is assumed that a user wishes to carry out print output with the use of the first print output apparatus 8. In this case, first, the user logs in to the first client apparatus 7 (personal computer or such) to use the first client apparatus 7. User authentication of the user is carried out as a result of the user logging in as mentioned above (in Step S21). Then, the user creates a document with the use of a document creating application which the first client apparatus 7 has, and makes a print output request for the created document. As a result, information of uid (user ID) of the user and a corresponding print command are transmitted to the first print output apparatus 8 (Step S22). The first print output apparatus 8 receives the information uid and print command, and transmits the uid to the image apparatus management apparatus 2 to inquire the image apparatus management apparatus of a toner save rate (Steps S23 and S24). The image apparatus management apparatus 2 receives the uid, obtain the toner save rate to be used when the user uses the first print output apparatus 8 from the user setting information 22 (Step S25), and returns information sv indicating the toner save rate, to the first print output apparatus 8 (Step S26). The first print output apparatus 8 then carries out printing out of the above-mentioned document according to the toner save rate indicated by the received information sv (Step S27).

It is noted that, the above-mentioned print command means a sequence of data including print commands for texts and objects for printing out an image processed with the use of a printer or such (i.e., the above-mentioned print output apparatus), other commands such as the number of copies, a paper size, and so fourth.

In the above description, the first image copying apparatus 3 and the second image copying apparatus 5 are used to copy an image, and the first print out apparatus 8 and the second print out apparatus 9 are used to print out an image. However, each of the first image copying apparatus 3, the second image copying apparatus 5, the first print output apparatus 8 and the second print output apparatus 9 may have both a copying function and a printing out function, i.e., may be a so-called MFP (Multi-Function Peripheral). In such a case, in FIG. 25, an image copying apparatus carrying out Steps S1, S2 and S5 may be any one of the first image copying apparatus 3, the second image copying apparatus 5, the first print output apparatus 8 and the second print output apparatus 9. Similarly, in FIG. 26, an image copying apparatus carrying out Steps S11, S12 and S16 may be any one of the first image copying apparatus 3, the second image copying apparatus 5, the first print output apparatus 8 and the second print output apparatus 9. Similarly, in FIG. 27, a print output apparatus carrying out Steps S23, S24 and D27 may be any one of the first image copying apparatus 3, the second image copying apparatus 5, the first print output apparatus 8 and the second print output apparatus 9.

### Variant Embodiment of First Embodiment

FIG. 28 depicts a processing flow and a data flow of an image forming apparatus management system in a variant embodiment of the first embodiment.

The image forming apparatus management system in the variant embodiment of the first embodiment has the same configuration as that of the first embodiment described above with reference to FIGS. 19 and 20.

As depicted in FIG. 28, in the variant embodiment of the first embodiment, the same as in the case of the first embodiment, first, the user logs in to the first client apparatus 7 (personal computer or such) to use the first client apparatus 7. User authentication of the user is carried out as a result of the user logging in as mentioned above (in Step S31). Then, the user creates a document with the use of a document creating application which the first client apparatus 7 has, and makes a print output request for the created document. As a result, information of uid (user ID) of the user, mid (machine ID) of the first print out apparatus 8 and a corresponding print command are transmitted to the image apparatus management apparatus 2 from the first client apparatus 7 (Step S32). The image apparatus management apparatus 2 receives the information uid, mid and print command, and, based on the information of uid and mid, obtain a toner save rate to be used when the user uses the first print output apparatus 8, from the user setting information 22 (Step S33). The image apparatus management apparatus 2 then transmits information sv indicating the toner save rate and the print command to the first print output apparatus 8 (Step S34). The first print output apparatus 8 receives the information sv and print command, and carries out print output operation of the above-mentioned document according to the toner save rate indicated by the received information sv (Step S35).

### Second Embodiment

An image forming apparatus management system in a second embodiment will now be described.

In an office environment of the image forming apparatus management system in the first embodiment as depicted in FIG. 19, in which the plurality of image copying apparatuses 3, 5, and the plurality of print out apparatuses 8, 9 are provided, it may be troublesome to set toner save rates separately for respective ones of many users. In the second embodiment, in order to reduce such trouble required for setting toner save rates for respective users, a configuration is provided such that toner save rates are set for the plurality of image copying apparatuses 3, 5, and the plurality of print out apparatuses 8, 9, according to a predetermined rule. That is, a configuration is provided in the image apparatus management apparatus 2 such that, by setting toner save rates for the image copying apparatuses 3, 5, setting of toner save rates for the print out apparatuses 8, 9 can be automatically carried out.

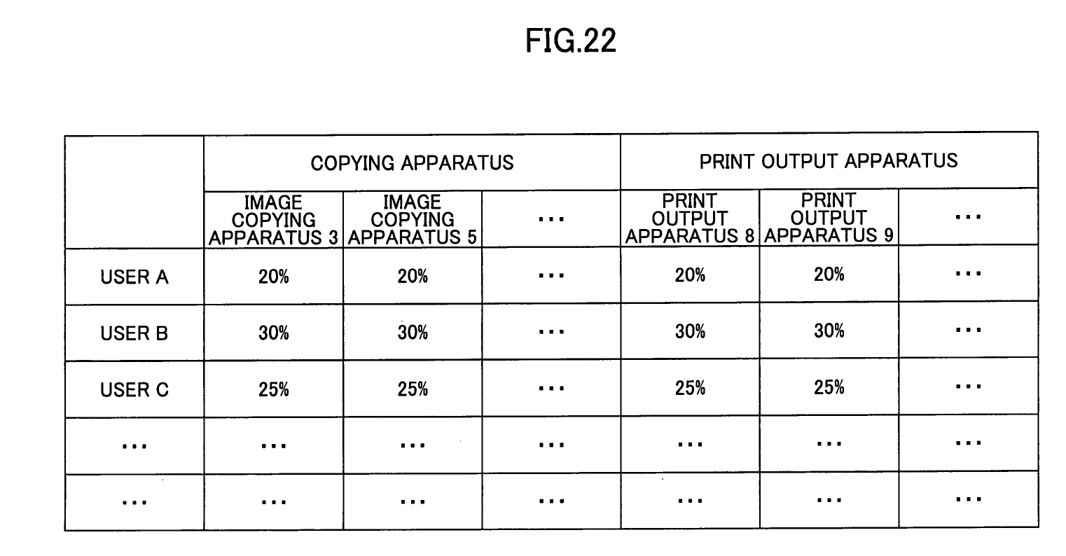

FIG. 22 depicts an example of setting of toner save rates in the second embodiment. In a table of toner save rates depicted in FIG. 22, the same toner wave rates are set for the image copying apparatuses 3, 5, and also, for the print out apparatuses 8, 9, for each user. By this configuration, for a user, the same toner save rates are set when the user uses any image output apparatus provided in a office, i.e., any one of the image copying apparatuses 3, 5, and the print out apparatuses 8, 9, to carry out copying or to carry out printing out. Thus, toner save rates can be collectively managed, and also, it is possible to obtain an image output through copying or printing out with toner save processing with uniform toner wave rates, with easy setting operation carried out by a manager (i.e., managing person).

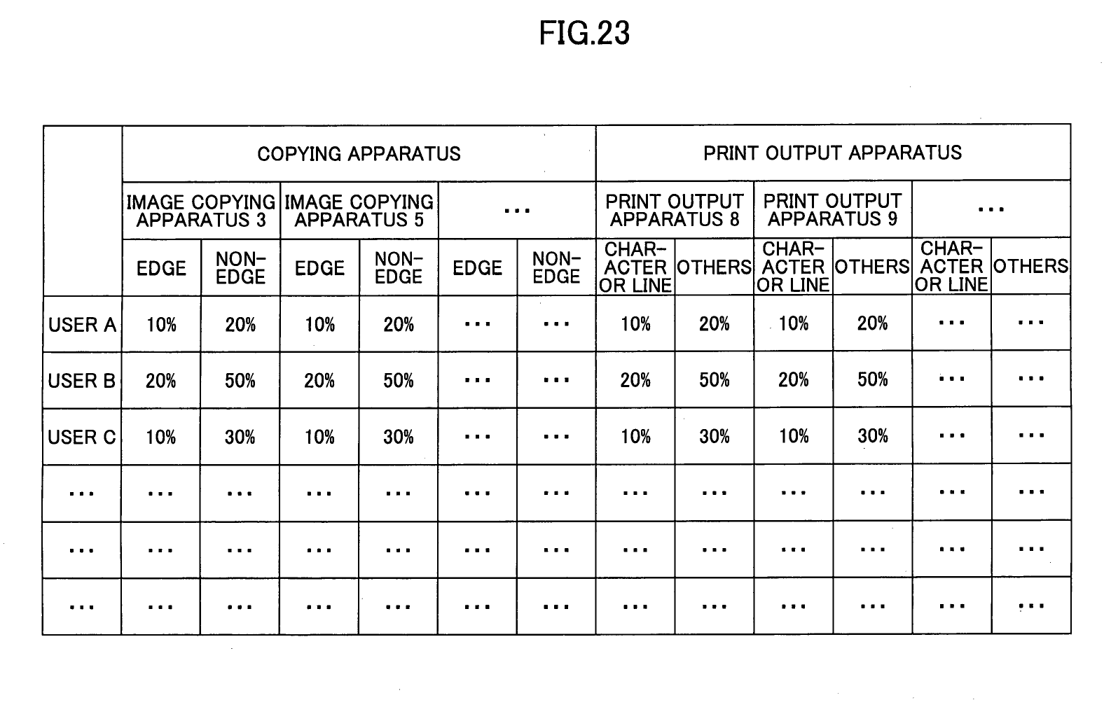

FIG. 23 depicts another example of setting of toner save rates, for an image forming apparatus management system regarding visibility of characters as important. In a table of toner save rates depicted in FIG. 23, set values for “edge” parts of an image processed for the first and second image copying apparatuses 3, 5 (i.e., 10%, 20%, 10%, . . . for users A, B, C, . . . , respectively) are the same as set values for “character-or-line” objects of an image processed for the first and second print output apparatus 8, 9 (i.e., 10%, 20%, 10%, . . . for users A, B, C, . . . , respectively), respectively. Similarly, set values for “non-edge” parts of an image processed for the image copying apparatuses 3, 5 (i.e., 20%, 50%, 30%, . . . for users A, B, C, . . . , respectively) are the same as set values for “others” (i.e., other objects) of an image processed for the first and second print output apparatus 8, 9 (i.e., 20%, 50%, 30%, . . . for users A, B, C, . . . , respectively), respectively.

### Third Embodiment

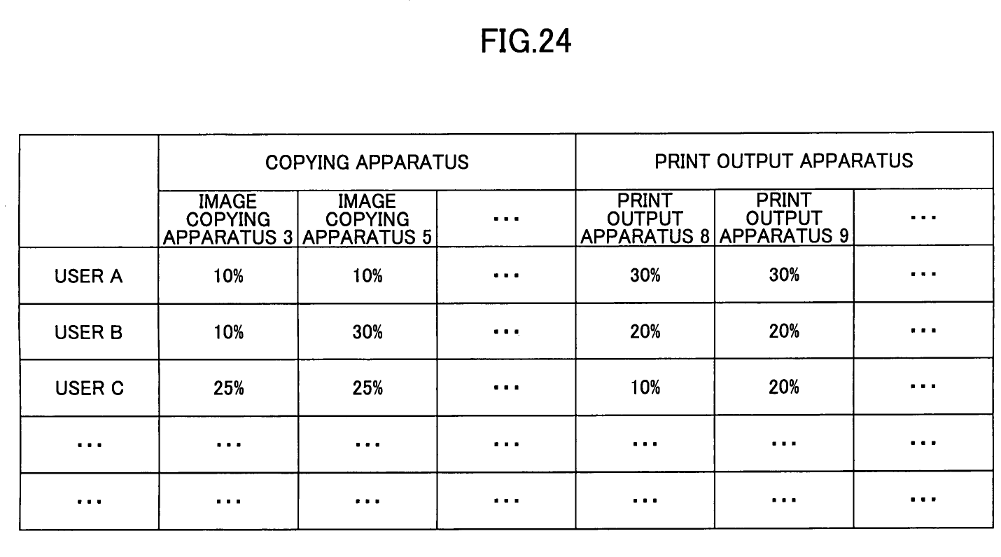

According to a third embodiment, described now, toner save rates are set according to a rule different from that in the above-described second embodiment. In an office, there may be a request for making approximately uniform toner save rates for respective users. In the third embodiment, in order to satisfy the request, toner save rates are set in such a manner that, an approximately equal value can be obtained for the respective users when toner save rates are averaged for the image copying apparatuses 3, 5 and the print output apparatuses 8, 9 for each user. FIG. 24 depicts an example of set values of toner save rates obtained from this rule.

In the example of FIG. 24, for each user, an average of the set values of toner save rates becomes 20%. For example, for a user A,

$$\{ 10 [ \% ] ( for the first image copying apparatus 3 ) + 10 [ \% ] ( for the second image copying apparatus 5 ) + 30 [ \% ] ( for the first print output apparatus 8 ) + 30 [ \% ] ( for the second print output apparatus 9 ) \} / 4 = ( 10 + 10 + 30 + 30 ) / 4 = 20 [ \% ]$$

Thereby, it is possible to control toner save rates for respective users in an average manner.

There may be a case where, percentages in use or frequencies in use of users vary for the respective image copying apparatuses 3, 5 and print output apparatuses 8, 9. That is, one user may use rather the image copying apparatuses 3, 5 frequently, and another user may use rather the print output apparatuses 8 and 9 frequently. For such a case, weights may be used for toner save rates, and the weights of the toner wave rates may be variably controlled for respective ones of the image copying apparatuses 3, 5 and the print output apparatus 8, 9, according to the percentages in use or the frequencies in use of the users, so that a weighted average of each user for all the image copying apparatuses 3, 5 and print output apparatuses 8, 9 can be made approximately equal.

### (Hardware Configuration)

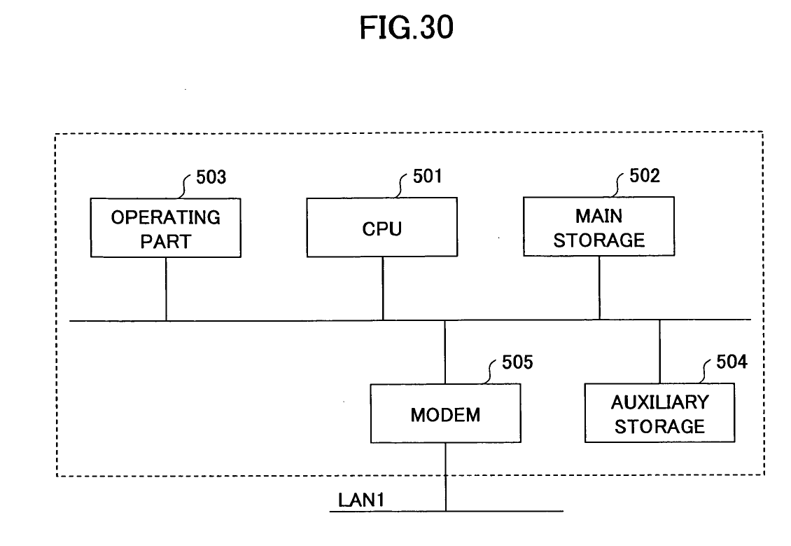

FIG. 30 depicts an example of a hardware configuration of each of the image apparatus management apparatus 2 and the first client apparatus 7 included in the image forming apparatus management system in the above-mentioned reference examples and embodiments. As depicted in FIG. 30, each of the image apparatus management apparatus 2 and the first client apparatus 7 has a CPU (Central Processing Unit) 501, a main storage 502, an auxiliary storage 504, a modem 505 and an operating part 503. The CPU 501 carries out various sorts of operation and calculation, and also, carries out control of the entirety of the image apparatus management apparatus 2 or the first client apparatus 7. A sort of operation carried out by the CPU 501, in the case of the image apparatus management apparatus 2, may be, for example, operation of realizing a function of the personal setting information inquiring part 21 described above with reference to FIG. 2. In the case of the first client apparatus 7, operation for a user to create a document with the use of a corresponding application is carried out by the CPU 501.

The main storage 502 has, for example, a ROM, a RAM and so forth for example, to store various data which the CPU 501 is to process or has processed, to provide a work area to the CPU 501, or to store programs to be executed by the CPU 501. The CPU 501 executes programs from the main storage 502, and thus, carries out the above-mentioned various sorts of operation/calculation, and control operation. The auxiliary storage 504 includes a hard disk drive, for example, to provide a supplementary storage capacity to the main storage 501.

The operating part 503 includes a keyboard, for example, to provide a function such that a user can input an instruction or data to the image apparatus management apparatus 2 or the first client apparatus 7. The modem 505 is connected to the communication network 1 such as a LAN, to provide a function such that the image apparatus management apparatus 2 or the first client apparatus 7 can communicate with another apparatus also connected with the communication network 1, as shown in FIG. 1 or FIG. 19.

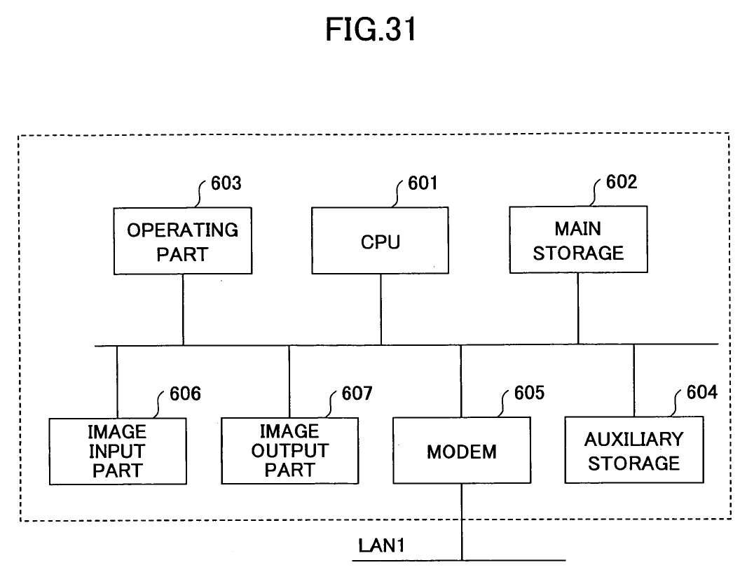

FIG. 31 depicts an example of a hardware configuration of each of the first image copying apparatus 3 and the second image copying apparatus 5 included in the image forming apparatus management system in the above-mentioned reference examples and embodiments. As depicted in FIG. 31, each of the first image copying apparatus 3 and the second image copying apparatus 5 has a CPU 601, a main storage 602, an auxiliary storage 604, a modem 605, an image input part 606, an image output part 607 and an operating part 603. The CPU 601 carries out various sorts of operation and calculation, and also, carries out control of the entirety of each of the first image copying apparatus 3 and the second image copying apparatus 5. Sorts of operation carried out by the CPU 601 include, for example, operation to realize the scanner y correcting part 102, image zone separating part 103, first edge amount calculating part 104, filtering part 105, under color removing and black generating part 107, compressing part 108, expanding part 110, second edge amount calculating part 111, toner save processing part 115, printer e correcting part 112, tone processing part 113, and so forth, described above with reference to FIG. 3 or FIG. 15. Further, in the case of the first image copying apparatus 3, the CPU 601 carries out operation to function as the first user authentication part 4 described above with reference to FIG. 1. In the case of the second image copying apparatus 5, the CPU 601 carries out operation to function as the second user reading part 6 described above with reference to FIG. 1.

The main storage 602 has, for example, a ROM, a RAM and so forth, for example, to store various data which the CPU 601 is to process or has processed, to provide a work area to the CPU 601, or to store programs to be executed by the CPU 601. The CPU 601 executes programs from the main storage 602, and thus, carries out the above-mentioned various sorts of operation/calculation and control operation. Further, the main storage 602 acts as the storing part 109 depicted in FIG. 3. The auxiliary storage 604 includes a hard disk drive, for example, to provide a supplementary capacity to the main storage 601.

The operating part 603 includes a keyboard, for example, to provide a function such that a user can input an instruction or data to the first image copying apparatus 3 or the second image copying apparatus 5. The modem 605 is connected to the communication network 1 such as a LAN, to provide a function such that the first image copying apparatus 3 or the second image copying apparatus 5 can communicate with another apparatus also connected with the communication network 1, as shown in FIG. 1 or FIG. 19.

The image input part 606 functions as the image input part 101 of FIG. 3, and the image output part 607 functions as the image output part 114 of FIG. 3.

Next, hardware configurations of the first print output apparatus 8 and the second print output apparatus 9 will be described.

Each of the first print output apparatus 8 and the second print output apparatus 9 has a hardware configuration the same as that of each of the first image copying apparatus 3 and the second image copying apparatus 5 described above with reference to FIG. 31, except that each of the first print output apparatus 8 and the second print output apparatus 9 may not include the image input part 606.

The present invention is not limited to the specifically disclosed embodiments, and variations and modifications may be made without departing from the scope of the present invention.

The present application is based on Japanese priority applications Nos. 2008-023219 and 2008-317331, filed Feb. 1, 2008 and Dec. 12, 2008, the entire contents of which are hereby incorporated herein by reference.

What is claimed is:

1. An image forming apparatus management system comprising at least one of a first and second image forming apparatuses having a copying function, a third image forming apparatus having a printing out function, a client apparatus, an image apparatus management apparatus and a communication network, wherein the at least one of the first and second image forming apparatuses, the third image forming apparatus, the client apparatus and the image apparatus management apparatus are connected in such a manner that they can communicate with each other through the communication network, wherein:
the first image forming apparatus comprises a first user authentication part configured to carry out authentication of a user based on user information, the first user authentication part carries out authentication of a user based on user information input by an operator, and the first image forming apparatus transmits the user information of the user authenticated by the first user authentication part,
the image apparatus management apparatus comprises a part configured to hold toner save setting information which sets a toner save rate for each user, and, when receiving the user information of the user authenticated by the first user authentication part, transmitted by the first image forming apparatus, the image apparatus management apparatus obtains a toner save rate of the user authenticated by the first user authentication part based on the user information of the user authenticated by the first user authentication part, and the toner save setting information held by the part configured to hold the toner save setting information, and transmits information indicating the toner save rate to the first image forming apparatus,
the first image forming apparatus receives the information indicating the toner save rate of the user authenticated by the first user authentication part transmitted from the image apparatus management apparatus, and carries out an image forming process based on the received toner save rate,
the second image forming apparatus transmits user information input by an operator,
the image apparatus management apparatus comprises a second user authentication part configured to carry out authentication of a user based on user information, the second user authentication part carries out, when receiving the user information transmitted by the second image forming apparatus, authentication of a user based on the user information, the image apparatus management apparatus obtains a toner save rate of the user authenticated by the second user authentication part based on the user information of the user authenticated by the second user authentication part and the toner save setting information held by the part configured to hold the toner save setting information, and transmits information indicating the toner save rate to the second image forming apparatus,
the second image forming apparatus receives the information indicating the toner save rate of the user authenticated by the second user authentications part, transmitted from the image apparatus management apparatus, and carries out an image forming process based on the received toner save rate,
the client apparatus comprises a third user authentication part configured to carry out authentication of a user based on user information, the third user authentication part carries out authentication of a user based on user information input by an operator, and the client apparatus transmits the user information of the user authenticated by the third user authentication part, to the third image forming apparatus,
the third image forming apparatus receives the user information of the user authenticated by the third user authentication part, and transmits the user information to the image apparatus management apparatus,
the image apparatus management apparatus receives the user information of the user authenticated by the third user authentication part, obtains a toner save rate of the user authenticated by the third user authentication part based on the user information and the toner save setting information held by the part configured to hold the toner save setting information, and transmits information indicating the toner save rate to the third image forming apparatus, and
the third image forming apparatus receives the information indicating the toner save rate of the user authenticated by the third user authentication part, transmitted from the image apparatus management apparatus, and carries out an image forming process based on the received toner save rate.

2. The image forming apparatus management system as claimed in claim 1, wherein:
the toner save rate is set according to a predetermined rule, separately for a case where the copying function is used and for a case where the printing out function is used.

3. The image forming apparatus management system as claimed in claim 2, wherein:
The predetermined rule is a rule such that, a value obtained from averaging the toner save rates for the case where the copying function is used and for the case where the printing out function is used is equal for all users.

4. An image forming apparatus management method for an image forming apparatus management system in which at least one of a first and second image forming apparatuses having a copying function, a third image forming apparatus having a printing out function, a client apparatus and an image apparatus management apparatus are connected in such a manner that they can communicate with each other through a communication network, said method comprising:
the first image forming apparatus carrying out authentication of a user based on user information input by an operator, and transmitting the user information of the authenticated user,
the image apparatus management apparatus, when receiving the user information of the user transmitted from the first image forming apparatus, obtaining a toner save rate of the user based on the user information transmitted from the first image forming apparatus and toner save setting information held by a part configured to hold the toner save setting information, and transmitting information indicating the toner save rate to the first image forming apparatus,
the first image forming apparatus receiving the information indicating the toner save rate of the user which has been obtained by the image apparatus management apparatus based on the user information having been transmitted from the first image forming apparatus, and carrying out an image forming process based on the received toner save rate,
the second image forming apparatus transmitting user information input by an operator,
the image apparatus management apparatus, when receiving the user information transmitted by the second image forming apparatus, carrying out authentication of a user based on the user information transmitted from the second image forming apparatus, obtaining a toner save rate of the user based on the user information transmitted from the second image forming apparatus and the toner save setting information held by the part configured to hold the toner save setting information, and transmitting information indicating the toner save rate to the second image forming apparatus,
the second image forming apparatus receiving the information indicating the toner save rate of the user which has been obtained based on the user information having been transmitted from the second image forming apparatus, and carrying out an image forming process based on the received toner save rate,
the client apparatus carrying out authentication of a user based on user information input by an operator, and transmitting the user information of the thus-authenticated user to the third image forming apparatus,
the third image forming apparatus receiving the user information transmitted from the client apparatus, and transmitting the user information to the image apparatus management apparatus,
the image apparatus management apparatus receiving the user information from the third image forming apparatus which has been transmitted from the client apparatus, obtaining a toner save rate based on the user information and the toner save setting information held by the part configured to hold the toner save setting information, and transmitting information indicating the toner save rate to the third image forming apparatus, and
the third image forming apparatus receiving the information indicating the toner save rate which has been obtained by the image apparatus management apparatus based on the user information having been transmitted from the client apparatus, and carrying out an image forming process based on the received toner save rate.
